(19) United States
(12) Patent Application Publication
(10) Pub. No.: US 2026/0017300 A1
(43) Pub. Date: Jan. 15, 2026

(54) INFORMATION PROCESSING APPARATUS, CORRECTING METHOD, AND NON-TRANSITORY RECORDING MEDIUM

(71) Applicant: PFU Limited, Ishikawa (JP)

(72) Inventors: Kiyoto KOSAKA, Ishikawa (JP); Masayoshi HAYASHI, Ishikawa (JP)

(21) Appl. No.: 19/242,272

(22) Filed: Jun. 18, 2025

(30) Foreign Application Priority Data
Jul. 12, 2024 (JP) 2024-112528

(51) Int. Cl. G06F 16/334; G06V 30/18

(52) U.S. Cl. CPC G06F 16/334; G06V 30/18019

(57) ABSTRACT

An information processing apparatus includes circuitry that: receives correction content indicating a change from a first character string extracted from first document data to a second character string; stores in a memory a document correction history representing the correction content of the first document data, and identical document information used for determining whether an input document has an identical format with the first document data; acquires second document data as the input document; extracts a third character string from the second document data; calculates a degree of match between the second document data and the identical document information; and when the degree of match is equal to or greater than a threshold value, and a comparison result between the third character string and the document correction history meets a predetermined condition, corrects the third character string based on the correction content represented by the document correction history.

### CROSS-REFERENCE TO RELATED APPLICATIONS

This patent application is based on and claims priority pursuant to 35 U.S.C. § 119 (a) to Japanese Patent Application No. 2024-112528, filed on Jul. 12, 2024, in the Japan Patent Office, the entire disclosure of which is hereby incorporated by reference herein.

### BACKGROUND

The present disclosure relates to an information processing apparatus, a correcting method, and a non-transitory recording medium.

Techniques for extracting a character string contained in document data such as image data include the following.

For example, some techniques (structured optical character recognition (OCR)) use a template corresponding to a structured document to extract a character string. Other techniques (semi-structured OCR) find an item name and an item value according to a definition to extract a character string. Still other techniques (unstructured OCR) understand the meaning of a document to extract a character string.

Documents subjected to structured OCR have respective fixed formats, such as application documents used within companies and cards used for personal authentication such as driver's licenses.

Documents subjected to semi-structured OCR are primarily forms handled between companies, such as invoices, receipts, purchase orders, delivery notes, or quotations. Since different companies have different document formats, the documents are diverse. Even the same documents of the same company may have slightly different content, and have similar formats.

Documents subjected to unstructured OCR are documents of any form such as contracts. Since document forms differ for different contracts, the documents subjected to unstructured OCR are diverse.

As a method for recognizing these documents, many engines have been proposed recently. By training artificial intelligence (AI) on a large number of documents, the engines gain the ability to extract character strings with high accuracy. However, even with the use of these engines, it is difficult to correctly extract all character strings as intended by users. The accuracy of recognition and character string extraction in information processing apparatuses decreases when documents contain company-specific content, such as the last month's invoice amount, or content where even humans have difficulty identifying the document type, such as a date lacking the written year, e.g., January 10.

### SUMMARY

An information processing apparatus according to one aspect of the present disclosure includes circuitry that: receives correction content indicating a change from a first character string extracted from first document data to a second character string; stores, in a memory, a document correction history representing the correction content of the first document data, and identical document information used for determining whether an input document has an identical format with the first document data; acquires second document data as the input document; extracts a third character string from the second document data; calculates a degree of match between the second document data and the identical document information; and when the degree of match is equal to or greater than a threshold value, and a comparison result between the third character string of the second document data and the document correction history meets a predetermined condition, corrects the third character string of the second document data based on the correction content represented by the document correction history.

A correcting method according to one aspect of the present disclosure includes: receiving correction content indicating a change from a first character string extracted from first document data to a second character string; storing, in a memory, a document correction history representing the correction content of the first document data, and identical document information used for determining whether an input document has an identical format with the first document data; acquiring second document data as the input document; extracting a third character string from the second document data; calculating a degree of match between the second document data and the identical document information; and when the degree of match is equal to or greater than a threshold value, and a comparison result between the third character string of the second document data and the document correction history meets a predetermined condition, correcting the third character string of the second document data based on the correction content indicated by the document correction history.

A non-transitory recording medium according to one aspect of the present disclosure stores a program, which, when executed by a computer, executes a correcting method including: receiving correction content indicating a change from a first character string extracted from first document data to a second character string; storing, in a memory, a document correction history representing the correction content of the first document data, and identical document information used for determining whether an input document has an identical format with the first document data; acquiring second document data as the input document; extracting a third character string from the second document data; calculating a degree of match between the second document data and the identical document information; and when the degree of match is equal to or greater than a threshold value, and a comparison result between the third character string of the second document data and the document correction history meets a predetermined condition, correcting the third character string of the second document data based on the correction content indicated by the document correction history.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram for describing an example process of performing automatic learning of incorrectly recognized document data instead of learning all pieces of document data;

FIG. 2 is a diagram for describing an example process of using not only ruled lines and item names but also item values, a table position, table items, a document title, and document paragraphs as determination criteria in determining whether an input document and training data have an identical document format;

FIG. 3 is a diagram for describing an example process of deleting training data when an engine is functionally enhanced enough for correct recognition by storing a name and a version of the engine in training data;

FIG. 4 is a diagram illustrating an example of a general arrangement of an OCR processing system;

FIG. 5 is a diagram illustrating an example of a hardware configuration of a character string extraction apparatus;

FIG. 6 is a block diagram illustrating an example of functional blocks of a scanner device and the character string extraction apparatus;

FIG. 7 is a flowchart of an example of an overall flow in which the character string extraction apparatus extracts a character string from an input document;

FIG. 8 is a diagram illustrating an example of a structured document;

FIG. 9 is a diagram illustrating an example of a semi-structured document;

FIG. 10 is a diagram illustrating an example of an unstructured document;

FIG. 11 is a diagram illustrating an example of text information recognized from the structured document;

FIG. 12 is a diagram illustrating an example of text information recognized from the semi-structured document;

FIG. 13 is a diagram illustrating an example of text information recognized from the unstructured document;

FIG. 14 is a diagram illustrating an example of character strings extracted from an invoice;

FIGS. 15A and 15B are diagrams for describing an example in which a user confirms and corrects extraction results of character strings;

FIG. 16 is a flowchart of an example in which a document learning unit determines whether to generate training data;

FIG. 17 is a diagram illustrating an example of identical document information;

FIG. 18 is a flowchart of an example process of generating the identical document information performed by the document learning unit;

FIG. 19 is a diagram for describing an example of a document correction history;

FIG. 20 is a diagram illustrating an example of engine specifying information;

FIG. 21 is a flowchart of an example of document correction performed by a document correction unit;

FIG. 22 is a diagram illustrating an example of a determination result of determining whether each character string has a match;

FIG. 23 is a flowchart of an example of a degree-of-match calculation method based on conditions 1 to 4;

FIG. 24 is a diagram for describing an example of a relative position based on an anchor set inside a statement table;

FIGS. 25A and 25B are diagrams for describing an example of a character string correction based on correction conditions in a case 1;

FIGS. 26A and 26B are diagrams for describing an example of a character string correction based on correction conditions in a case 2;

FIGS. 27A and 27B are diagrams for describing an example of a character string correction based on correction conditions in a case 3;

FIGS. 28A and 28B are diagrams for describing an example of a character string correction based on correction conditions in a case 4;

FIGS. 29A and 29B are diagrams for describing an example of a character string correction based on correction conditions in a case 5;

FIGS. 30A and 30B are diagrams for describing an example of a character string correction based on correction conditions in a case 6;

FIGS. 31A and 31B are diagrams for describing an example of a character string correction based on correction conditions in a case 7;

FIGS. 32A and 32B are diagrams for describing an example of a character string correction based on correction conditions in a case 8; and

FIG. 33 is a flowchart of an example of automatically updating training data in response to a change of the engine.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A character string extraction apparatus and a correction method performed by the character string extraction apparatus will be described below as an example of embodiments of the present disclosure.

### Overview of Character String Extraction

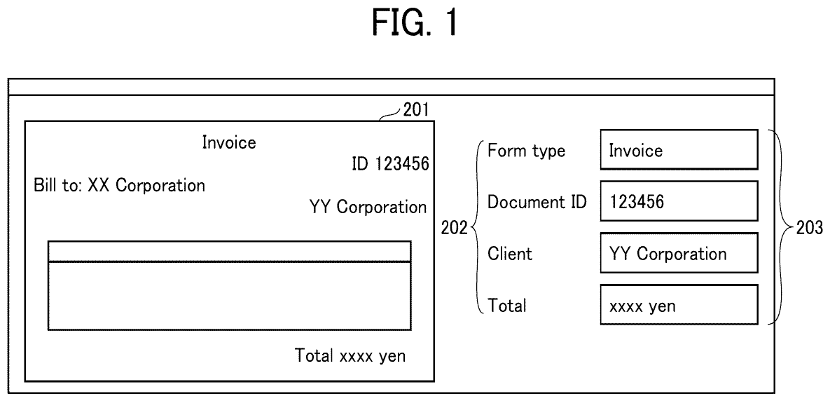

An overview of character string extraction according to the present embodiment is described with reference to FIGS. 1 to 3.

A character string extraction apparatus according to the present embodiment performs automatic learning of only incorrectly recognized document data, instead of learning all pieces of document data in advance as in structured OCR of the related art. This reduces the amount of training data and reduces the time to determine whether an input document and the training data have an identical format (are identical documents). The format defines positions where respective pieces of data such as items are arranged and attributes of the pieces of data (for example, how the date or the like is written), and is also referred to as a form or a style.

In determining whether the input document and the training data have an identical document format (are identical documents), the character string extraction apparatus uses not only ruled lines and item names but also positions of item values, item names of a statement table, a layout of the statement table, sentences, and a document layout as determination criteria. This allows the character string extraction apparatus to accurately determine whether the input document and the training data have the identical format even when the input document is diverse. The statement table refers to information represented in a tabular form. The tabular form is a form having one or more columns in the horizontal direction, one or more rows in the vertical direction, and a value written in each cell (field or square) corresponding to a row and column. The statement table may be referred to simply as a “table”.

To determine whether the input document and the training data have an identical document format, the character string extraction apparatus selects the training data by document type and company name and then analyzes the detailed document structure, rather than making the determination with all conditions at once. This allows the character string extraction apparatus to quickly determine whether the input document and the training data have an identical document format, even when training data is present for diverse documents.

The character string extraction apparatus stores the name and version of each engine together in training data, and deletes the training data when the engine is changed by functional enhancement (version-up or upgrade) to gain the ability to correctly extract a character string. This allows the character string extraction apparatus to automatically update the training data to the correct state.

The character string extraction apparatus stores a correction history of a correction made by the user when a character string is not correctly extracted. The character string extraction apparatus further assumes cases where a character string is incorrectly extracted, and determines whether a correction condition prepared for each of the cases is met. When the correction condition is met, the character string extraction apparatus makes a correction using a correction method corresponding to the correction condition. This allows the character string extraction apparatus to prevent an incorrect correction when a correction is made based on a document correction history. This also allows the character string extraction apparatus to make a correction when failing to correctly extract the character string due to the same error for which the correction history is registered.

FIG. 1 is a diagram for describing a process of performing automatic learning of only incorrectly recognized document data instead of learning all pieces of document data. FIG. 1 illustrates an example of a screen of the character string extraction apparatus. The screen displays scanned image data 201 on the left, and item names 202 and item values 203, which are extraction results of character strings, on the right. The user can determine whether the item values 203 are incorrectly recognized, based on comparison between the image data 201 and the item values 203. The character string extraction apparatus determines that extraction is not correctly performed on the document data when the user corrects the item values 203. The character string extraction apparatus learns the item values 203 of the document data 201 and position information of the item values 203 designated by the user. This process allows the character string extraction apparatus to learn the minimum number of documents, thus reducing the amount of the training data and the time taken for comparison processing between the identical document information and the input document.

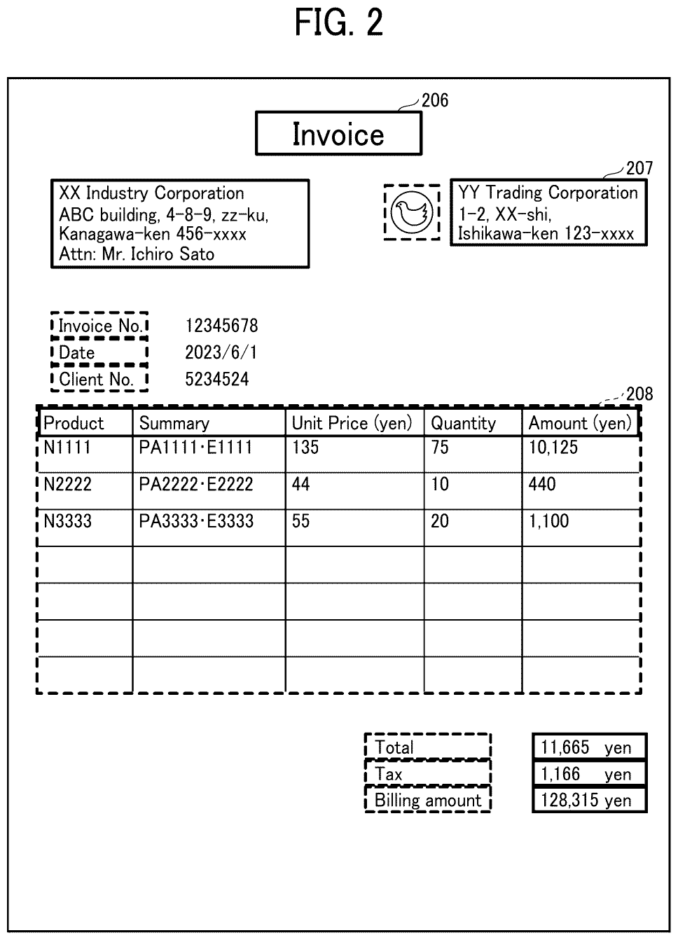

FIG. 2 is a diagram for describing an example process of using not only ruled lines and item names but also positions of item values, item names of a statement table, a layout of the statement table, text information contained in rows, and a document layout as determination criteria in determining whether an input document and training data have an identical document format. In FIG. 2, a range enclosed by a rectangle is extracted as one character string. A rectangle 206 represents a document type. A rectangle 207 represents company information. A rectangle 208 represents a statement table. The use of the document type, the company information, and the statement table as identity determination criteria allows the character string extraction apparatus to accurately determine whether the input document and the training data are identical even for diverse documents. In the related art, it is determined whether the input document and the training data have an identical document format, based only on the item names and the ruled lines of the statement table.

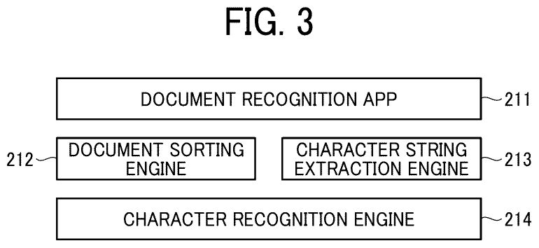

FIG. 3 is a diagram for describing a process of deleting training data when an engine is changed by functional enhancement or the like to gain the ability to correctly extract a character string, by storing a name and a version of the engine in training data. The character string extraction apparatus includes components such as a document recognition application (app) 211, a character recognition engine 214, a document sorting engine 212, and a character string extraction engine 213. The character recognition engine 214, the document sorting engine 212, and the character string extraction engine 213 are available from various companies, and the most suitable one is selected and implemented. When any one of these engines is changed by functional enhancement to gain the ability to correctly extract a character string, the character string extraction apparatus deletes the training data. Since the training data is generated for the new engine thereafter, the training data can be automatically kept up-to-date information. Since at least a part of the character string extraction apparatus 2, such as the document sorting engine 212, the character string extraction engine 213, and the character recognition engine 214, is functionally enhanced automatically, the accuracy of the character string extraction apparatus 2 can be automatically increased.

### Terminology

Document data includes various character strings. The character strings include a character string having a set of an item name and an item value, a character string having a value such as the company name or the address, a character string in a statement table, and a character string contained in a row. The item value varies for a different input document.

However, the company name, the address, the item name, and the like do not vary. Thus, some character strings vary from document to document, while others do not. In the present embodiment, the character strings refer to, for example, the document type, the company information, the item values, and the item values of the statement table. The character strings include those represented by character codes such as characters, numerical values, symbols, and alphabets. In the case of prose-form document data such as contracts, such document data also includes the character strings.

Types of the document data include image data and character-string-containing data. The character-string-containing data is data in which character strings are already represented by character codes. In the case of the image data, characters are recognized by OCR processing, so that character strings are extracted. In the case of the character-string-containing data, the data includes character strings (character codes). Thus, OCR is not performed.

### Example of System Configuration

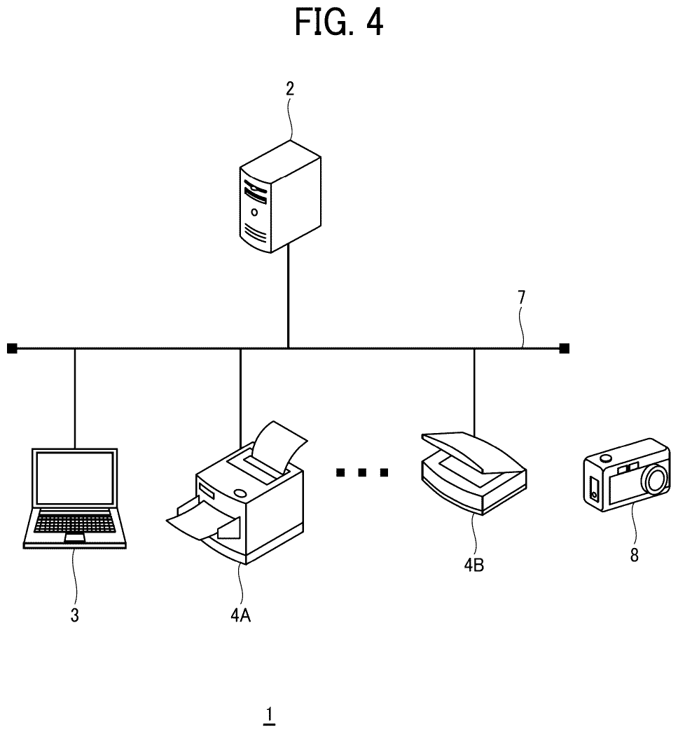

An example of a configuration of an OCR processing system 1 is described below. FIG. 4 is a diagram illustrating an example of the general arrangement of the OCR processing system 1. As illustrated in FIG. 4, the OCR processing system 1 includes a character string extraction apparatus 2, scanner devices 4A and 4B, and a terminal apparatus 3, which communicate with one another via a network 7. In the present embodiment, any one of the scanner devices 4A and 4B is referred to as a “scanner device 4”.

The network 7 may be, for example, an in-house local area network (LAN). The network 7 may be implemented by wireless communication such as Wi-Fix. When the character string extraction apparatus 2 is in the cloud, the network 7 may include a wide area network (WAN) or Internet. For example, the terminal apparatus 3 can acquire image data obtained by the scanner device 4 through reading, and transmit the image data to the character string extraction apparatus 2. This image data is an example of document data. The document data may be character-code-containing data containing character strings (character codes), instead of the image data.

The character string extraction apparatus 2 may be directly connected to the scanner device 4 by a cable such as a Universal Serial Bus (USB) cable in a one-to-one manner. In the case of one-to-one connection, the character string extraction apparatus 2 and the scanner device 4 may wirelessly communicate with each other. Examples of such a communication method include Wi-Fi Direct® and Bluetooth®.

The character string extraction apparatus 2 may be a general-purpose information processing apparatus. The character string extraction apparatus 2 performs character recognition and data extraction on the image data of the input document received from the scanner device 4, and allows the user to confirm or correct the extraction result. In the present embodiment, the character string extraction apparatus 2 may perform character recognition using the OCR technology, on the image data of the input document received from the scanner device 4.

Specifically, the character string extraction apparatus 2 may be a personal computer (PC), a server apparatus, a smartphone, or a tablet PC, for example.

The scanner device 4 is an optical reading device. The scanner device 4 reads an original to generate image data, and transmits the image data to the character string extraction apparatus 2. In the present embodiment, the scanner device 4 scans various documents each serving as an example of the input document. FIG. 4 illustrates the scanner device 4. However, image data subjected to character recognition may be obtained by a digital camera 8 or the like through imaging. The image data obtained by the digital camera 8 through imaging may be transmitted via the network 7, or stored in a removable storage medium. When the user attaches the storage medium to the character string extraction apparatus 2, the character string extraction apparatus 2 can acquire the image data.

The scanner device 4 may be a device called a multifunction peripheral (MFP). That is, the scanner device 4 may have a printer function, a copy function, and a facsimile function in addition to a scanner function.

In FIG. 4, the scanner device 4 and the character string extraction apparatus 2 are separate apparatuses. However, the scanner device 4 and the character string extraction apparatus 2 may be integrated into a single apparatus (e.g., MFP).

The terminal apparatus 3 is a general-purpose information processing apparatus such as a PC, a smartphone, or a tablet PC. When the character string extraction apparatus 2 is a server apparatus, the terminal apparatus 3 transmits the document data received from the scanner device 4 to the character string extraction apparatus 2. The terminal apparatus 3 acquires a character string extracted by the character string extraction apparatus 2. The terminal apparatus 3 may acquire the document data from the scanner device 4 or hold the document data input by the user.

### Example of Hardware Configuration

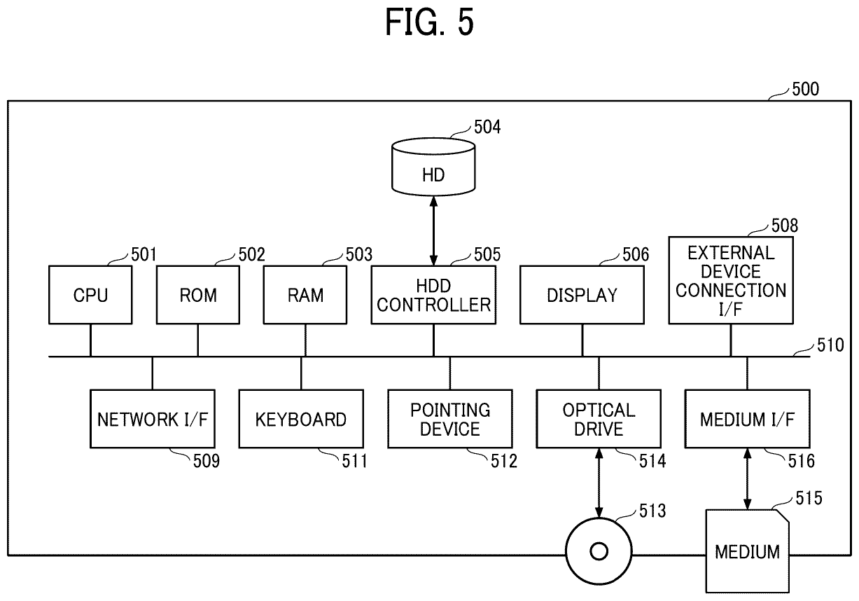

An example of a hardware configuration of the character string extraction apparatus 2 according to the present embodiment is described with reference to FIG. 5. FIG. 5 is a diagram illustrating an example of the hardware configuration of the character string extraction apparatus 2 according to the present embodiment. The character string extraction apparatus 2 is implemented by a computer 500. As illustrated in FIG. 5, the computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls overall operation of the computer 500. The ROM 502 stores a program for executing the CPU 501, such as an initial program loader (IPL). The RAM 503 is used as a work area for the CPU 501. The HD 504 stores various kinds of data such as a program. The HDD controller 505 controls reading or writing of various kinds of data from or to the HD 504 under control of the CPU 501. The display 506 displays various kinds of information such as a cursor, a menu, a window, text, or an image. The external device connection I/F 508 is an interface that connects the computer 500 to various external devices. Examples of the external devices include a Universal Serial Bus (USB) memory and a printer. The network I/F 509 is an interface for communicating data via the network 7. The bus line 510 is, for example, an address bus or a data bus for electrically connecting the components illustrated in FIG. 5, such as the CPU 501, with each other.

The keyboard 511 is an example of an input device that includes a plurality of keys for inputting characters, numerical values, or various instructions. The pointing device 512 is another example of the input device that allows the user to select or execute a specific instruction, select a target for processing, or move the cursor. The optical drive 514 controls reading or writing of various kinds of data from or to an optical recording medium 513 that is an example of a removable recording medium. The optical recording medium 513 may be a compact disc (CD), a digital versatile disc (DVD), or a Blu-ray® disc. The medium I/F 516 controls reading or writing (storing) of data from or to a recording medium 515 such as a flash memory.

### Functions

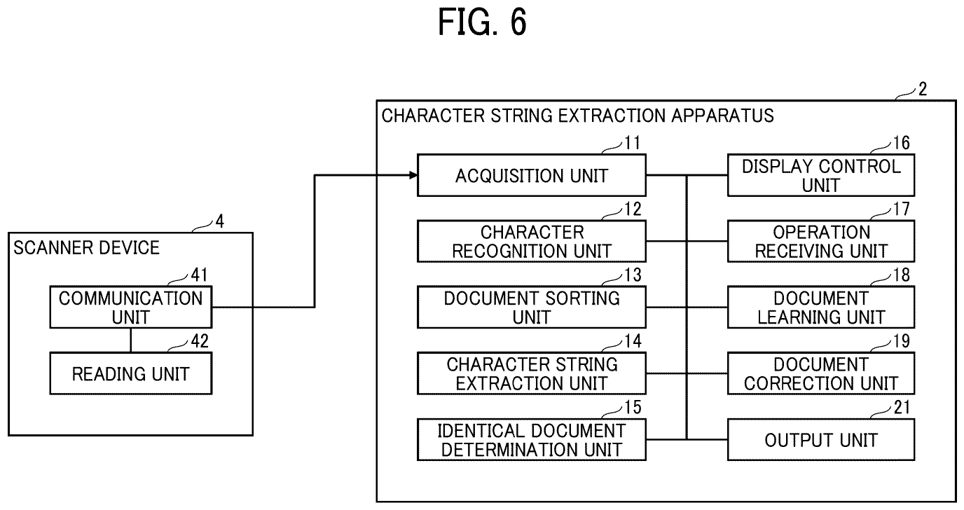

An example of functions of the character string extraction apparatus 2 is described in detail below with reference to FIG. 6. FIG. 6 is a block diagram illustrating an example of functional blocks of the scanner device 4 and the character string extraction apparatus 2.

### Scanner Device

The scanner device 4 includes a communication unit 41 and a reading unit 42. The reading unit 42 feeds documents such as forms one by one. The reading unit 42 scans a face of an original with a line sensor to generate image data having a certain resolution and a certain gradation. Instead of the scanner device 4, the digital camera 8 or a device having a camera function may acquire image data of an input document.

The communication unit 41 communicates with the character string extraction apparatus 2 according to a communication protocol such as Simple Network Management Protocol (SNMP) or communicates with the character string extraction apparatus 2 via a dedicated line such as a USB cable. The communication unit 41 transmits the image data generated by the reading unit 42 to the character string extraction apparatus 2.

The scanner device 4 does not have to be used when the document data is the character-string-containing data. In this case, the character string extraction apparatus 2 acquires the character-string-containing data from an external apparatus such as the terminal apparatus 3.

### Character String Extraction Apparatus

The character string extraction apparatus 2 includes an acquisition unit 11, a character recognition unit 12, a document sorting unit 13, a character string extraction unit 14, an identical document determination unit 15, a display control unit 16, an operation receiving unit 17, a document learning unit 18, a document correction unit 19, and an output unit 21. These units of the character string extraction apparatus 2 are functions or units that are implemented as a result of the CPU 501 of the character string extraction apparatus 2 executing commands in a program. The program may be, for example, a native app dedicated to a scanner in the case where the scanner functions as the character string extraction apparatus 2, or a general-purpose native app. The program may be a web app.

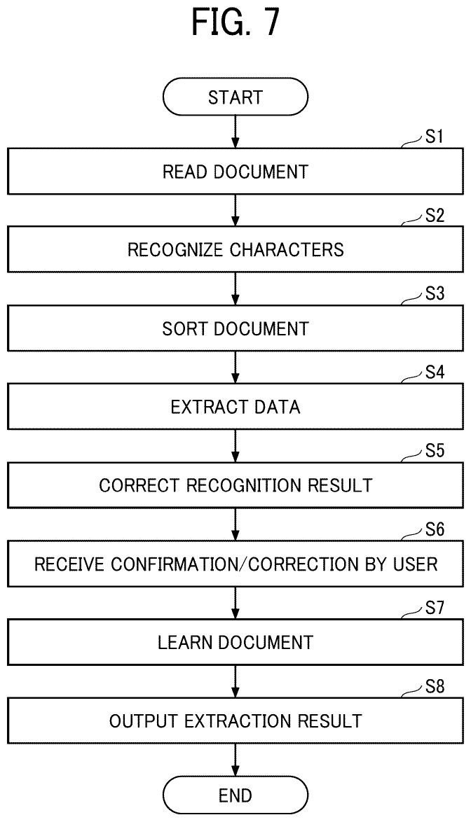

These functional units are described with reference to a flowchart of FIG. 7. FIG. 7 is a flowchart of an example of an overall flow in which the character string extraction apparatus 2 extracts a character string from an input document.

In step S1, the scanner device 4 or the digital camera 8 reads an input document with the reading unit 42 and creates image data. When the image data is already digital data such as portable document format (PDF), the reading unit 42 obtains an image of the digital data and captures the resultant image to acquire the image data. When the input document is character-string-containing data, the scanner device 4 does not read the original. The image data of the input document or the character-string-containing data is referred to as document data. The communication unit 41 transmits the document data to the character string extraction apparatus 2. The acquisition unit 11 of the character string extraction apparatus 2 acquires the document data. Alternatively, the acquisition unit 11 may receive the document data from the terminal apparatus 3, or the acquisition unit 11 may read the document data from a memory card or the like. The acquisition unit 11 can control the scanner device 4 via the network 7. The character string extraction apparatus 2 has a Technology Without An Interesting Name (TWAIN) driver installed thereon. The TWAIN is the standard that defines technical specifications for capturing image data by controlling an input device such as an image scanner from a scanner app running on a computer.

In step S2, the character recognition unit 12 uses the character recognition engine 214 to acquire “text information” from the document data. The text information includes character codes and positions of respective characters. When the input document is image data, the character recognition unit 12 performs OCR on the image data.

In step S3, the document sorting unit 13 uses the document sorting engine 212 to analyze the layout of the document data and the text information to sort the document data by document type.

In step S4, the character string extraction unit 14 uses the character string extraction engine 213, which is prepared according to the document type, to extract character strings relevant to the document from the text information as data from the document data. The relevant character strings are, for example, the amount and the date in the case of slips, the billing amount and the client in the case of invoices, and the contractor name and the date in the case of contracts.

In step S5, the document correction unit 19 corrects the extraction result. The document correction unit 19 holds content of corrections (training data) made in the past in relation to the document data from which the character strings were extracted. The training data will be described in detail below. When generating the training data, the document correction unit 19 determines whether the input document and the training data have the identical format. The format refers to the description form of the document type, the company information, the item name, the layout of the statement table, or the document layout. When the input document and the training data have the identical format, the input document and the training data are inferred to be the identical documents. When it is determined that the input document and the training data have the identical format, the document correction unit 19 corrects the character strings, based on the training data generated for the corresponding document data.

In step S6, the display control unit 16 displays the document data and the character strings. The user checks the extraction result and corrects the incorrectly extracted character string if there is any. The operation receiving unit 17 receives the correction made by the user.

In step S7, the document learning unit 18 generates training data based on content of the correction made by the user. The training data is stored in association with the identical document (document format, more specifically).

In step S8, the output unit 21 outputs the extraction result of the character strings obtained through the processing above. The output form may be a csv file, an xml file, or the like. The data is transferred via an I/F of a related application, and the application may output the data.

### Details of Each Step

Each step of the flowchart of FIG. 7 will be described in detail below.

### S1: Reading of Document

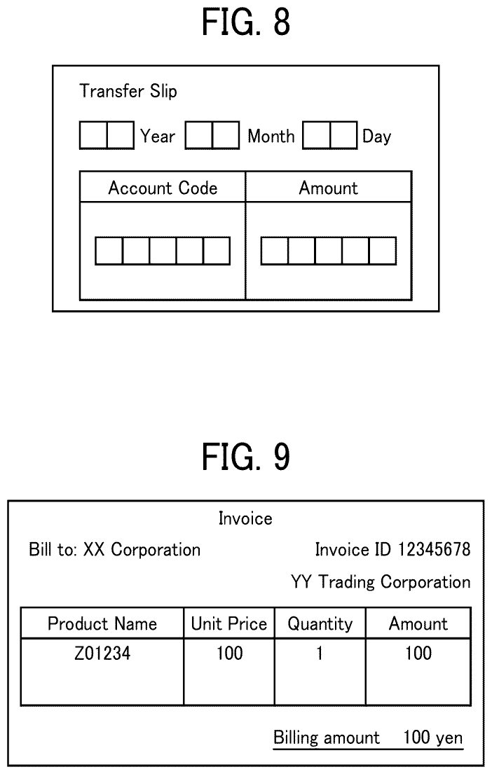

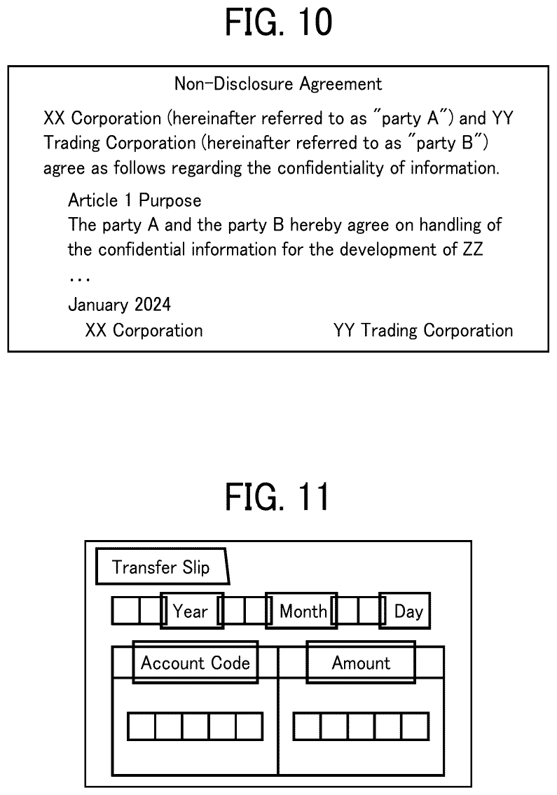

As described above, documents primarily include three types, i.e., structured documents, semi-structured documents, and unstructured documents. FIGS. 8 to 10 illustrate examples of a structured document, a semi-structured document, and an unstructured document, respectively. For example, structured documents are documents whose formats are uniquely determined by document type, such as application documents used within companies and cards used in personal authentication (e.g., driver's license or identification card). Semi-structured documents are forms handled between companies, such as invoices, receipts, purchase orders, delivery notes, or quotations. Semi-structured documents have different formats for different companies, and thus are diverse. Even semi-structured documents from the same company may have slightly different content. Thus, the formats may be similar but slightly different. Unstructured documents are documents having indefinite formats such as contracts. Since the formats differ for different contracts, the unstructured documents are diverse.

When such diverse documents are paper documents, the reading unit 42 reads the paper documents to convert each of the paper documents into image data (e.g., JPEG, PNG, BMP, or PDF file format). When the diverse documents are digital documents (containing character codes) such as PDF available from Adobe Inc. and Word available from Microsoft Corporation, the reading unit 42 performs file format conversion to convert each of the digital documents into image data (e.g., JPEG, PNG, BMP, or PDF file format). Thus, the paper documents and the digital documents can be processed in the same manner. As described later, the text information may be extracted using a method for processing digital documents without conversion. In the case of character-code-containing data, OCR is omitted.

### S2: Recognition of Characters

When the document data is image data, the character recognition unit 12 performs OCR to acquire “text information including layout information”. The character recognition unit 12 uses the character recognition engine 214 or is integrated with the character recognition engine 214. The layout information is position information related to each character string, a statement table, or the like. Photos and logs are also extractable. Thus, positions of paragraphs and rows in the prose form become apparent. When the document data is character-code-containing data, character recognition is not to be performed.

In the case of character-code-containing data, the character recognition unit 12 extracts “text information including layout information” from the character-code-containing data.

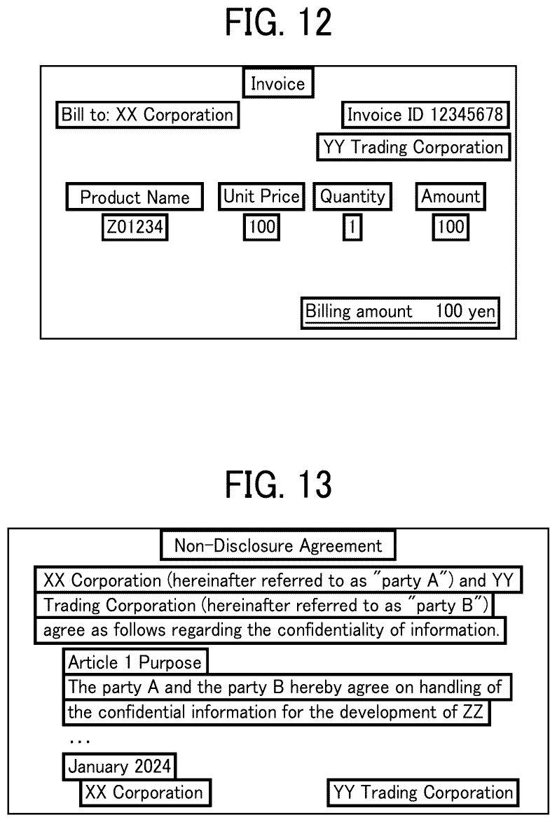

FIGS. 11 to 13 illustrate examples of the structured document, the semi-structured document, and the unstructured document from each of which pieces of text information are extracted. In each of the documents, the text information is enclosed by a rectangle.

### S3: Sorting of Document

The document sorting unit 13 analyzes the “text information including the layout information” to identify the document type. For example, the document sorting unit 13 holds ruled line information (lengths and positions of ruled lines) in association with the document type, and determines whether the ruled line information of the input document matches the held ruled line information. When the ruled line information of the input document matches the held ruled line information, the document learning unit 18 sorts the document by the document type. The title name is stored in association with the document type in advance. The document sorting unit 13 determines whether the title name of the input document is identical to the stored title name to sort the document. The document sorting unit 13 may analyze the content of the input document using AI or the like to sort the document by the document type. The document sorting unit 13 uses the document sorting engine 212 or is integrated with the document sorting engine 212.

### S4: Extraction of Data

The character string extraction unit 14 extracts, as data of the input document, a character string corresponding to the document type from the “text information including the layout information”. Specifically, in the case of a document sorted to the transfer slip exemplified as the structured document, the character string extraction unit 14 extracts character strings such as the document title, the creation date, the account code, and the amount, for example. In the case of a document sorted to the invoice exemplified as the semi-structured document, the character string extraction unit 14 extracts character strings such as the document title, the recipient company information, the client company information, the invoice ID, the transaction details (product name, unit price, quantity, and amount), and the billing amount. In the case of a document sorted to the contract exemplified as the unstructured document, the character string extraction unit 14 extracts character strings such as the document title, the recipient company information, the client company information, and contract date. The character string extraction unit 14 uses the character string extraction engine 213 or is integrated with the character string extraction engine 213.

The character string extraction methods include the use of the character string extraction engine 213 since the character string extraction engine 213 trained for each document type is provided by various companies. The character string extraction methods include the method for training AI on a large amount of data to extract information desirably recognized, and the method for extracting a character string using the rule base of an existing technology (such as at which position, which characters are present, at which position the ruled line is present, or at which position the statement table is present). When many documents have an identical format such as structured documents, positions to be recognized such as ruled line information may be learned in advance to extract the character strings.

In the rule-based extraction method, a developer creates a rule base in which an item name indicating a character string “Invoice ID” and a numerical value “12345678” on the right side of the “Invoice ID” is an item value is created in advance for the document containing characters “Invoice ID 12345678”, for example. The character string extraction unit 14 searches the text information for the “Invoice ID” to extract the desirably extracted character string located on the right side of the “Invoice ID”. When the document contains “Billed to: XX Corporation” but contains no “recipient company name”, the character string extraction unit 14 searches for “Corporation”. If the character string extraction unit 14 detects a character string (e.g., Bill to:) located near the company name, the character string extraction unit 14 extracts the company name also as the “recipient company name”. As described above, the character string extraction unit 14 acquires the item value based on the item name, the position information of the item name, the item value, or the position information of the item value to extract the character string.

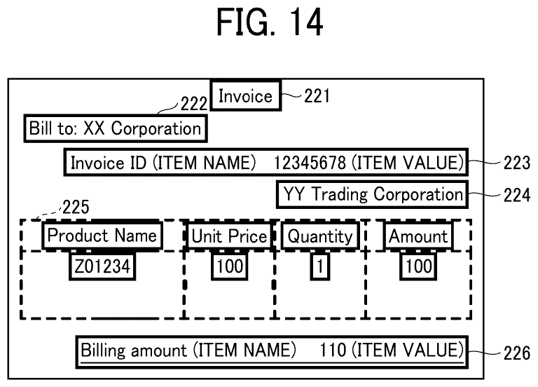

FIG. 14 is a diagram illustrating an example of character strings extracted from the invoice. A document type 221, a recipient company name 222, an invoice ID and character string 223, a client company name 224, a statement information 225, and a billing amount and character string 226 are extracted.

### S5: Correction of Recognition Result

The training data is used for correction of the recognition result. Thus, correction of the recognition result will be described after generation of the training data is described.

### S6: Receipt of Confirmation/Correction by User

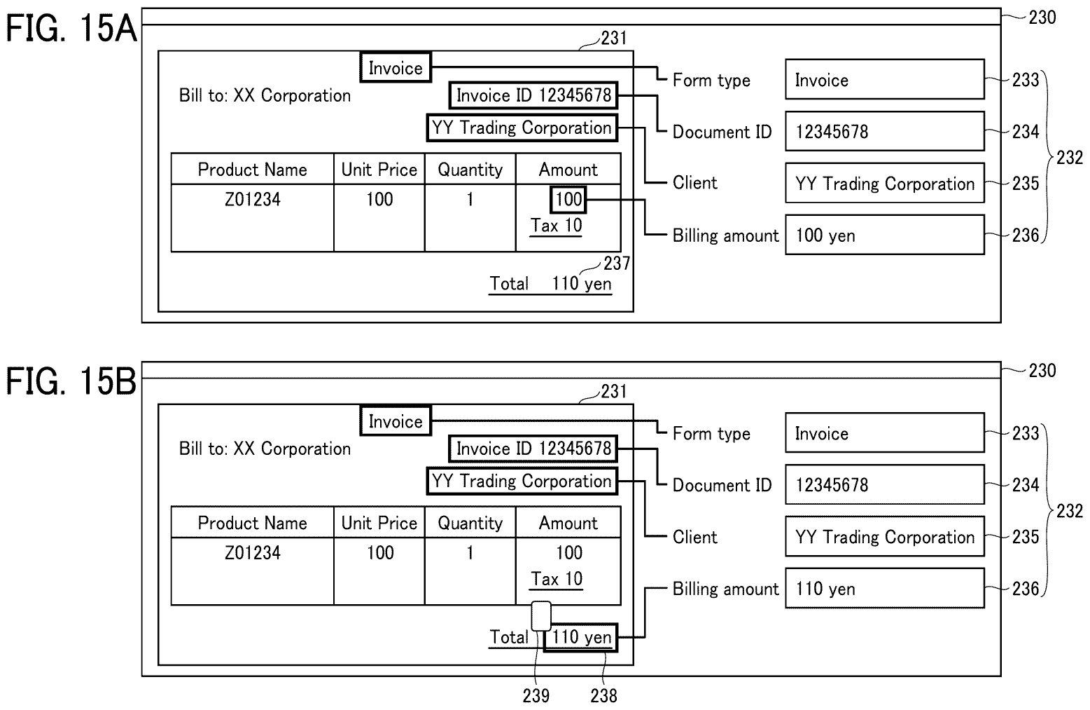

FIGS. 15A and 15B are diagrams for describing an example in which the user confirms and corrects extraction results of character strings. FIG. 15A illustrates a confirmation-correction screen 230 displayed by the character string extraction apparatus 2. The confirmation-correction screen 230 displays document data 231 of the input document on the left and extraction results 232 obtained by the character string extraction unit 14 on the right. In the document data 231, positions of item values of a form type 233, a document ID 234, a client 235, and a billing amount 236 extracted from the document data 231 are illustrated with rectangles. These rectangles are linked to the extraction results 232 by respective lines. These lines are illustrated for the description, and can be displayed as a result of the character string extraction unit 14 managing the correspondences between the rectangles and the extraction results 232.

An item value “100 yen” is extracted for the billing amount 236. Since a total 237 in the document data 231 is “110 yen”, “110 yen” is correct as the billing amount 236. Thus, the user corrects the item value of the billing amount 236.

FIG. 15B illustrates the confirmation-correction screen 230 in which the user has corrected the item value of the billing amount 236. The billing amount 236 is corrected to “110 yen”. The correction method will be described. The user uses a mouse or the like to surround a region 238 to be recognized in the document data 231. The region 238 is displayed with a marking 239 which indicates the user's correction. The character recognition unit 12 performs OCR to recognize the character string in the designated region 238. Suppose that the recognized character string is “110 yen”. The document learning unit 18 uses the recognized “110 yen” and corrects the item value of the billing amount 236 to “110 yen”. Since the input document is determined as the invoice, the document learning unit 18 recognizes that the item value of the billing amount is present in the region 238 designated by the user. Alternatively, the user may explicitly associate the item value of the billing amount 236 with the region 238 designated by the user. When the character recognition unit 12 incorrectly recognizes characters even after the user designates the region 238, the user may input the correct item value for the billing amount 236 with the keyboard 511.

The confirmation-correction screen 230 displays the document sorting result and the character string extraction results. When the user sets desirably acquired results beforehand, the confirmation-correction screen 230 may display some of the extraction results designated by the user.

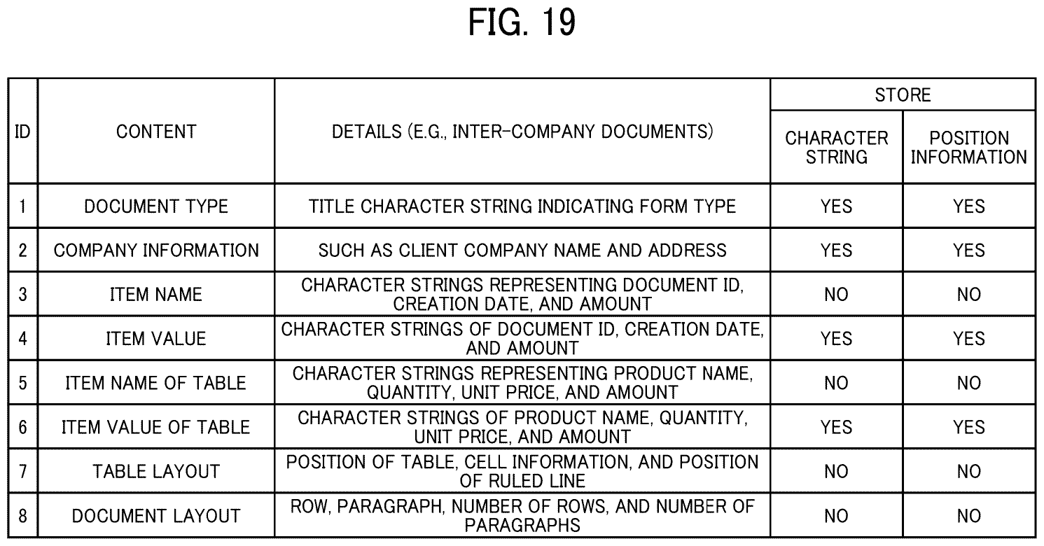

The position of the region 238 corrected by the user is stored in the document correction history. The corrected item value “110 yen” is also stored in the document correction history. Whether to store the information in the document correction history is predetermined as described below referring to FIG. 19.

When the user has confirmed or corrected all the items, the process of FIG. 7 proceeds to the next step (S7) in response to the user operation.

### S7: Learning of Document

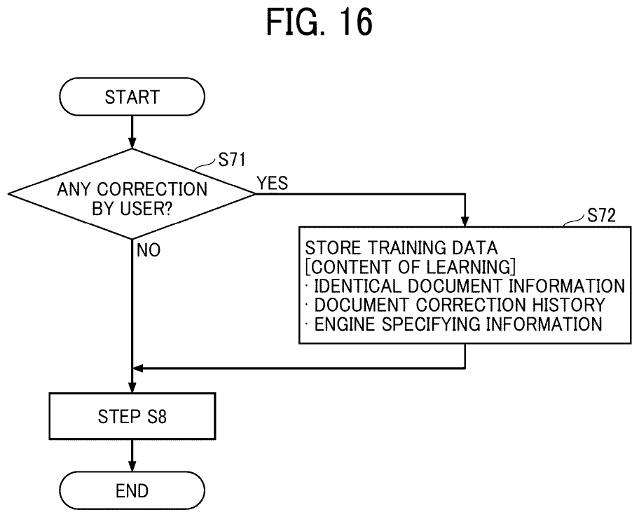

As illustrated in FIG. 16, the document learning unit 18 generates training data when the user has corrected the extraction result. FIG. 16 is a flowchart of an example in which the document learning unit 18 determines whether to generate training data.

In step S71, the document learning unit 18 determines whether the user has corrected the extraction result in step S6. This determination is made based on whether the user has designated a region in the document data 231 or has corrected any of the extraction results 232. When the determination in step S71 is Yes, the process proceeds to step S72. When the determination in step S71 is No, the process proceeds to step S8.

In step S72, the document learning unit 18 learns the input document. In step S72, learning refers to generating and storing the training data. The training data includes “identical document information” for determining whether the document is identical to the training data, a “document correction history” indicating the history of corrections made in the document, and “engine specifying information” for specifying a corrected recognition engine. The identical document information, the document correction history, and the engine specifying information will be described below.

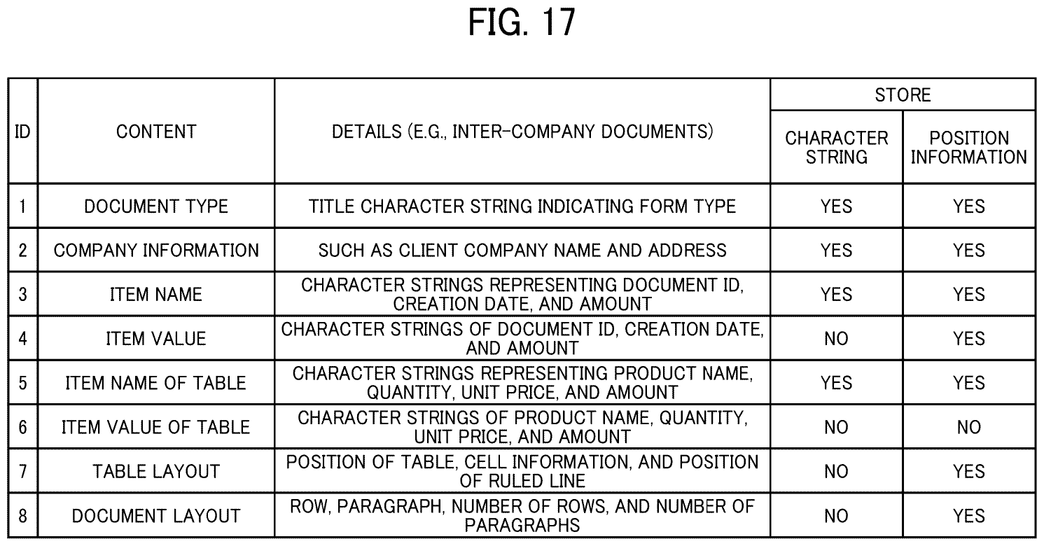

FIG. 17 illustrates an example of the identical document information. The identical document information is generated from results obtained by character recognition, document sorting, and data extraction.

An ID represents identification information for identifying an item of the identical document information.

Content represents data in the input document extracted by the character string extraction unit 14 (all character strings extracted from the input document).

Details represent an explanation of each character string. The explanation of each character string is prepared in advance. The details are presented for the illustrative purpose and may be omitted from the identical document information.

An item “STORE” indicates whether to store (“YES”) or not to store (“NO”) the character string and the position information in “CHARACTER STRING” and “POSITION INFORMATION”, respectively. The position information is coordinates of the character string. For example, the document type, the company information, the item names, and the item names of the table do not vary (thus are usable in determination of the identical document), both the character string and the position information are stored. The item values vary for each input document. Thus, the character string is not stored and the position information is stored. The item values of the table vary for each input document. Thus, neither the character string nor the position information is stored because the position information also vary depending on the number of rows of the statement table. The position information alone is stored for the table layout and the document layout. The character string may be stored for the document layout.

The table layout includes one or more of position information for identifying an outer frame of the statement table, position information of all cells (also called fields or squares) of the statement table, and position information of ruled lines forming the cells. All cells refer to cells for which the position information is acquirable. Thus, the position information of some cells may not be stored. The document layout includes position information of rows and position information of paragraphs. The paragraphs refer to indented lines or a row block spaced apart by one or more rows. The number of rows and the number of paragraphs are also stored as the document layout. Even when the number of rows and the number of paragraphs are not stored, the number of rows and the number of paragraphs are countable at a given timing since the positions of the rows and the paragraphs are recorded.

Which of “YES” or “NO” is to be stored in FIG. 17 is determined in advance depending on data. That is, “YES” is set for “STORE”, for character strings to be used for determining whether the input document is the identical document among those extracted from the input document.

The document type and the company information are an example of character strings that do not vary, the item names and the item names of the table are an example of character strings that do not vary, and the item values and the item values of the table are an example of varying character strings.

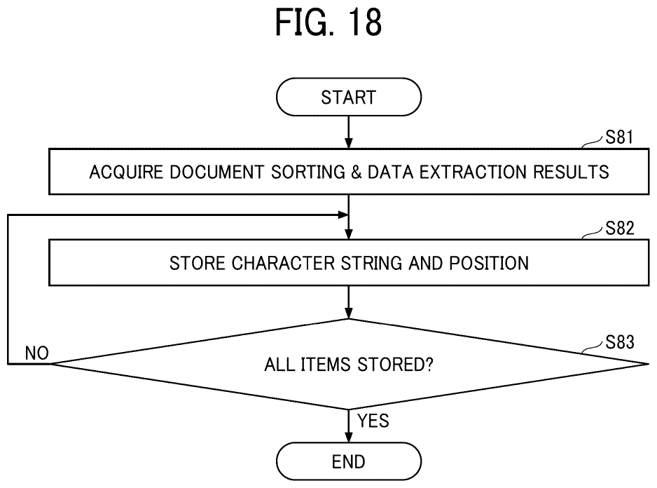

FIG. 18 is a flowchart of an example process of generating the identical document information performed by the document learning unit 18. The process of FIG. 18 is performed in step S72 in FIG. 16, for example.

In step S81, the document learning unit 18 acquires the document sorting result and the data extraction result.

In step S82, the document learning unit 18 acquires, from the text information, a character string for which “YES” is set for “STORE” in the identical document information and a position of the character string, and stores the character string for which “YES” is set for “STORE” in the identical document information and the position information of the character string as the identical document information. The character string and the position information that are stored are those before correction.

In step S83, the document learning unit 18 iterates step S82 until all the character strings determined in advance according to the document type are acquired.

FIG. 19 is a diagram for describing an example of the document correction history. In one example, the document correction history stores, for the character string having been corrected by the user, the extracted character string and the position information of the extracted character string, and a user correction result (the corrected character string and the position information of the corrected character string). More specifically, the incorrectly extracted character string and the position information of the incorrectly extracted character string are stored together with the user correction result. However, as illustrated in FIG. 19, whether to store one or both of the character string and the position information for the specific content is previously set.

An ID presents identification information for identifying an item of the document correction history.

Content represents data in the input document extracted by the character string extraction unit 14 (all character strings extracted from the input document).

Details represent an explanation of each character string. The explanation of each character string is prepared in advance. The details are presented for the illustrative purpose and may be omitted from the document correction history.

As for the items “CHARACTER STRING” and “POSITION INFORMATION” of the item “STORE”, “YES” indicating to store or “NO” indicating not to store when the user has corrected each character string is set. In other words, the character string for which “YES” is set for storage and which has been corrected by the user is stored in the document correction history. When “YES” is set for the item “STORE” of the position information and the user has corrected the to-be-recognized position, the position of the character string is stored in the document correction history. Whether to set “YES” or “NO” for the item “STORE” is determined in advance depending on extracted data (content).

The document correction history is used not only for correcting the character string extracted from the input document but also for the document correction unit 19 to determine whether to correct the character string extracted from the input document (correction conditions (1) to (12) described later). The character strings of the document type, the company information, the item values, and the item value of the table that are used in the correction and the determination are stored. The pieces of position information of the document type, the company information, the item values, and the item values of the table are also stored. On the other hand, the character strings and the pieces of position information of the item names, the item names of the table, the table layout, and the document layout are not character strings subjected to extraction, and thus are used in neither the correction nor the determination as to whether to correct. Thus, the character strings and the pieces of position information of the item names, the item names of the table, the table layout, and the document layout are not stored.

In this example, “YES” is set for storage of the character string, the character strings to be stored are the incorrectly extracted character string before correction and the character string after correction. “YES” is set for storage of the position information, the pieces of position information to be stored are the incorrectly extracted position information before correction and the position information after correction.

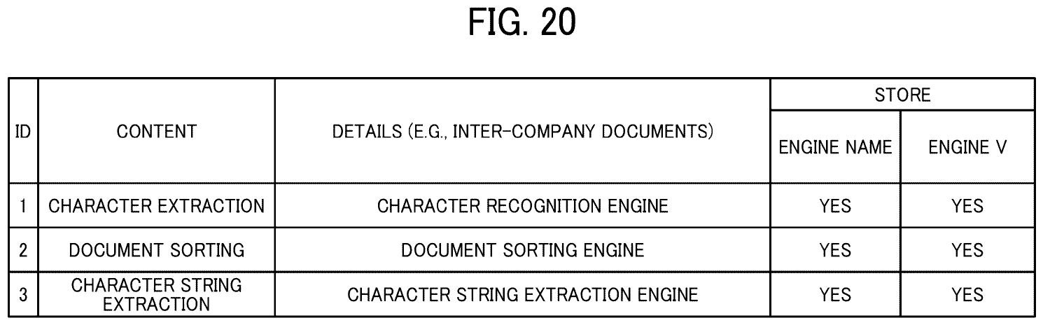

FIG. 20 illustrates an example of the engine specifying information. The engine specifying information is information related to the character recognition engine 214, the document sorting engine 212, and the character string extraction engine 213.

An ID represents identification information for identifying an item of the engine specifying information.

Content represents the function of the engine.

Details represent the engine name.

The name and the version of each engine are stored (saved) in the engine name field and the engine version (V) field. When these engines are integrated, the engines may be collectively managed. In this case, a single engine is stored.

### S8: Output

The output unit 21 outputs the extraction results of the character strings obtained through the processing above. The output form may be a csv file, an xml file, or the like. The data is transferred via an I/F of a related application, and the application may output the data.

### S5: Correction of Recognition Result

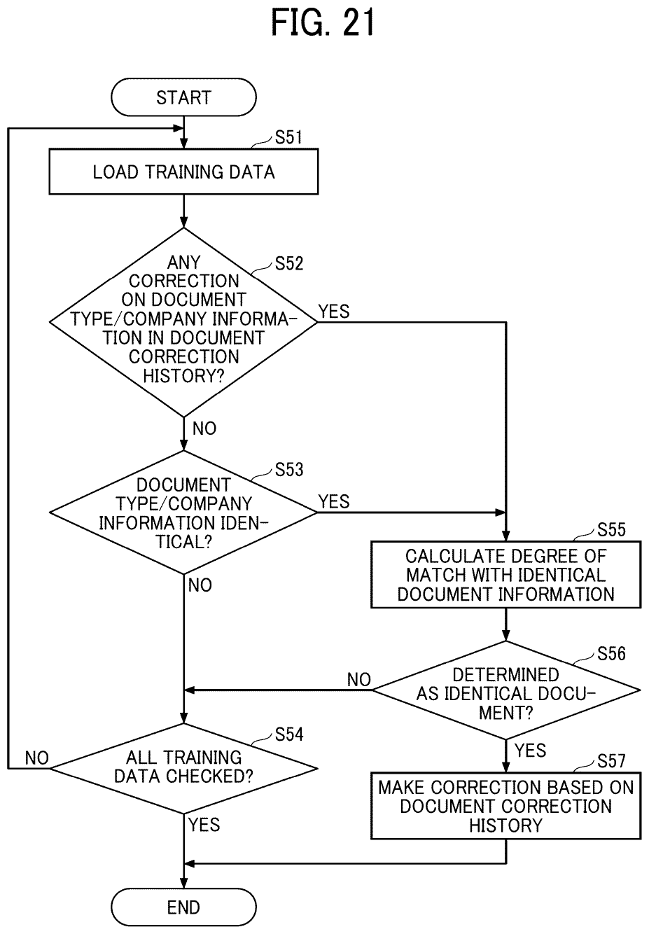

Correction of the recognition result is described below with reference to FIG. 21 and other figures. FIG. 21 is a flowchart of an example of a document correction process performed by the document correction unit 19.

First, in step S51, the document correction unit 19 loads the training data (the identical document information, the document correction history, and the engine specifying information).

In step S52, the identical document determination unit 15 determines whether the document type or the company information has been corrected, with reference to the document correction history. When the user has corrected the document type or the company information, the document correction history stores the document type before correction, the document type after correction, the position of the document type before correction, and the position of the document type after correction.

When the determination in step S52 is Yes, the process proceeds to step S55. When the determination in step S52 is No, the process proceeds to step S53. When the determination in step S52 is Yes, the same error as that has been corrected may be caused in the input document read by the scanner device 4.

In step S53, the identical document determination unit 15 determines whether the document type or the company information in the identical document information is identical to the document type or the company information included in the extraction result. When the determination in step S53 is Yes, the process proceeds to step S55. When the determination in step S53 is No, the process proceeds to step S54.

As indicated in step S53, the identical document determination unit 15 first determines whether the document type and the company information match between the identical document information and the input document, and performs step S55 when the document type and the company information match between the identical document information and the input document. Thus, the training data can be selected and the determination as to whether the input document is the identical document can be made more quickly.

In step S54, the identical document determination unit 15 determines whether all the training data has been checked. When the determination in step S54 is Yes, the process of FIG. 21 ends. When the determination in step S54 is No, the process returns to step S51.

In step S55, to determine whether the loaded training data is usable for correction of the input document, the identical document determination unit 15 calculates a degree of match between the identical document information and the input document. Although the details will be described later, the document correction unit 19 calculates the degree of match using the information stored in the identical document information as illustrated in FIG. 17. Thus, for at least one of the document type (character string and position information), the company information (character string and position information), the item name (character string and position information), the item value (position information), the item name of the table (character string and position information), the table layout (position information), or the document layout (position information), the document correction unit 19 compares the character string and the position information in the identical document information with the character string and the position information in the input document to calculate the degree of match. The comparison is performed for the character string and the position information for which “YES” is set for storage in the identical document information as illustrated in FIG. 17. This can reduce the time to determine whether the input document matches.

In step S56, the identical document determination unit 15 compares the degree of match with a threshold value to determine whether the input document is an identical document. The identical document determination unit 15 determines that the input document is an identical document when the degree of match is greater than or equal to the threshold value. When the determination in step S56 is Yes, the process proceeds to step S57. When the determination in step S56 is No, the process proceeds to step S54.

In step S57, since it is determined that the training data for learning the input document is found, the document correction unit 19 corrects the extracted character string based on the document correction history. Note that when a correction condition, which is prepared on assumption of the cases where the character string may be incorrectly extracted, is met, the document correction unit 19 makes a correction according to the met correction condition to suppress incorrect corrections.

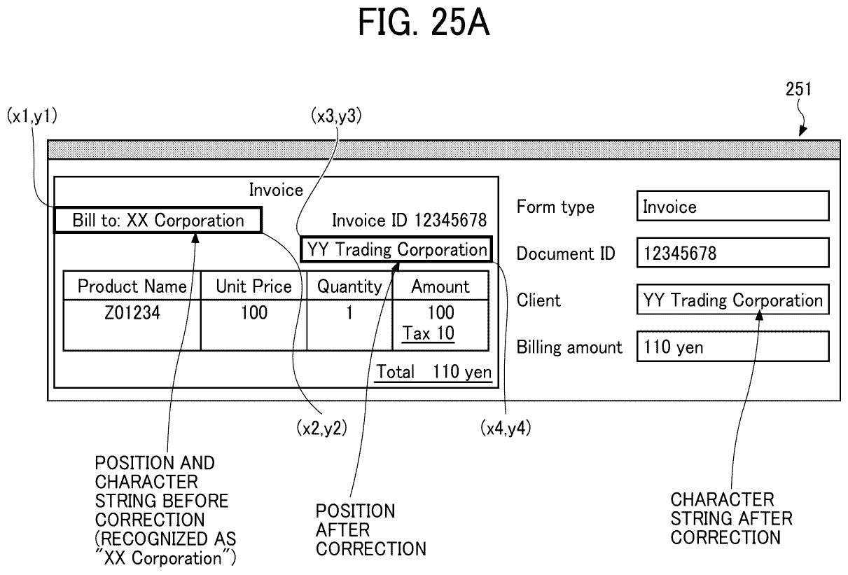

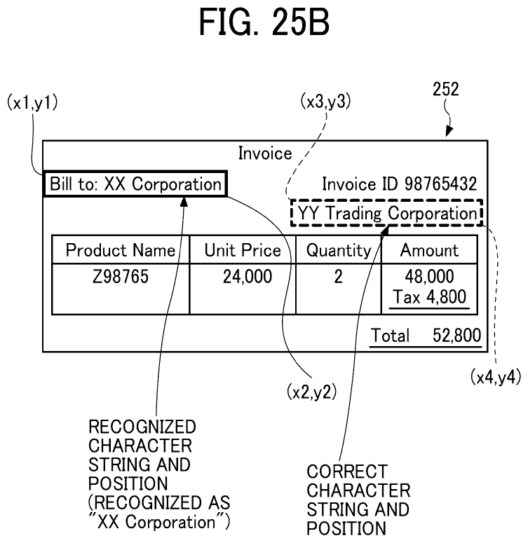

The determination as to whether to make a correction using the document correction history and the correction method will be described with reference to FIGS. 25 to 32.

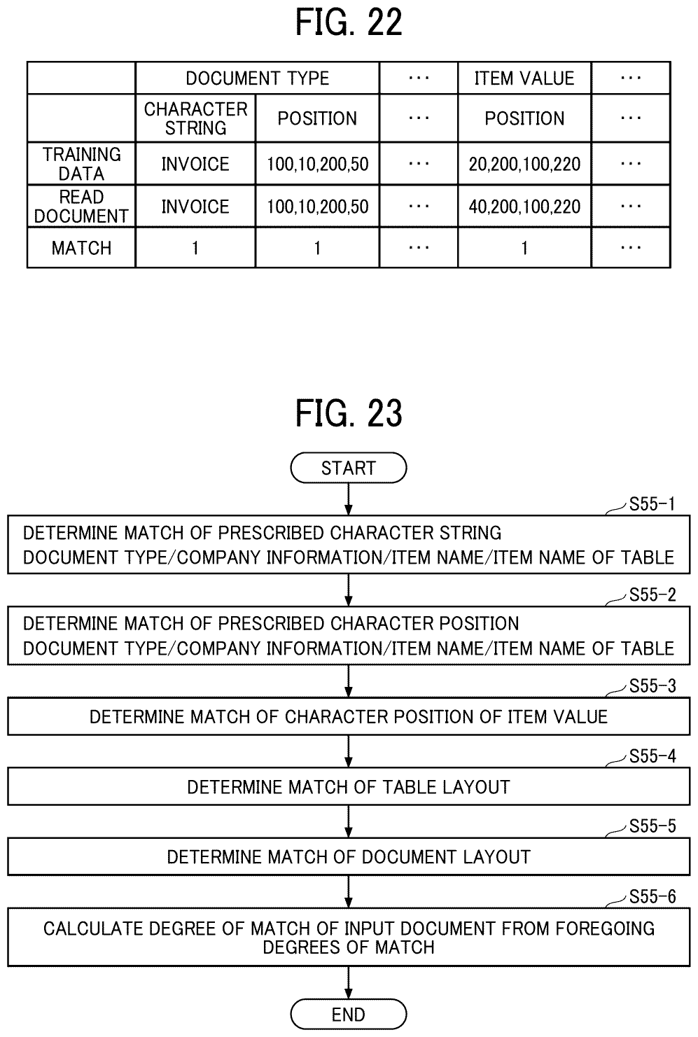

The method for calculating the degree of match between the identical document information and the input document in step S55 is described below. FIG. 22 is a diagram for describing an example of a determination result of determining whether each data extracted from the input document matches the identical document information. The document correction unit 19 compares the identical document information and the input document to calculate the degree of match. The document correction unit 19 determines whether the conditions are met for each of the conditions.

### Condition 1

The document correction unit 19 determines whether the character strings and the pieces of position information of “the document type, the company information, the item name, and the item name of the table” are identical between the identical document information and the input document. The character strings being identical does not necessarily require the complete match and permits a difference between the full width and the half width. When the character string of the input document includes the number of characters greater than or equal to a threshold value (e.g., 90%) of the character string of the identical document information, the character strings may be determined to be identical. Likewise, the positions of the character strings being identical does not necessarily require the complete match. When a difference between the position of the character string of the identical document information and the position of the character string of the input document is less than a threshold value (e.g., a half the character size), the positions may be determined to be identical. This determination method also applies to the conditions 2 to 4.

### Condition 2

In the case of the “item value”, the document correction unit 19 determines whether the position information is identical between the identical document information and the input document. It may be determined whether the position information is identical based on whether a region with fewer recognized characters overlap the other. Note that the complete overlap is not necessarily requested, and the regions may overlap with a certain percentage or more in the area. Alternatively, when the difference between the position of the item value of the identical document information and the position of the item value of the input document is less than a threshold value (e.g., a half the character size), the positions may be determined to be identical.

### Condition 3

The document correction unit 19 determines whether the table layout is identical between the identical document information and the input document. The method may be determining the positions of the corresponding statement tables or determining whether the positions of the corresponding cells or ruled lines match. The complete match in the position is not necessarily requested. For example, the positions of the corresponding statement tables may be regarded to be identical even when a difference of about 5% of the size of the statement table included in the identical document information is present. The positions of the corresponding cells may be regarded to be identical even when a difference of about 50% of the size of the cell included in the identical document information is present. The positions of the corresponding ruled lines may be regarded to be identical even when a difference of about 50% of a space between the ruled lines included in the identical document information is present and a difference of 10% to 20% of the length of the ruled line is present. In addition, the document correction unit 19 may determine whether a difference in the number of cells is less than a threshold value.

### Condition 4

The document correction unit 19 determines whether at least one of the number of rows or the number of paragraphs is identical between the identical document information and the input document. The complete match is not necessarily requested for the number of rows and the number of paragraphs. For example, the numbers of rows and the numbers of paragraphs may be regarded to be identical even when a difference of about 10% of the number of rows or the number of paragraphs included in the identical document information is present. The document correction unit 19 determines whether the text information included in all the rows matches between the identical document information and the input document. The complete match is not necessarily requested for the text information. For example, when the text information of the input document includes the number of character strings greater than or equal to a threshold value (e.g., 90%) of the text information of the identical document information, the input document may be determined to be an identical document.

The document correction unit 19 counts, for each data, whether the data meets the conditions 1 to 4, and determines a matching ratio to calculate the degree of match. In FIG. 22, whether the character string and the position information of the document type match, whether the position of the item value matches, or the like is set. When a match is determined, an item “match” has “1”. When a mismatch is determined, the item “match” has “0”. The document correction unit 19 uses “the total sum of 1 of the matching items/the number of all items subjected to determination” as the degree of match.

FIG. 23 is a flowchart of an example of the degree-of-match calculation method based on the conditions 1 to 4.

In step S55-1, the document correction unit 19 determines whether each of prescribed character strings matches between the identical document information and the input document, based on the condition 1. The prescribed character strings include the document type, the company information, the item name, and the item name of the table (condition 1).

Likewise, in step S55-2, the document correction unit 19 determines whether the position of each of the prescribed character strings matches between the identical document information and the input document, based on the condition 1. The prescribed character strings include the document type, the company information, the item name, and the item name of the table (condition 1).

In step S55-3, the document correction unit 19 determines whether the character position of the item value, which is a varying value, matches between the identical document information and the input document, based on the condition 2. That is, for the item whose item value varies each time, the comparison is made on the character position alone (condition 2).

In step S55-4, the document correction unit 19 then determines whether the table layout matches between the identical document information and the input document, based on the condition 3. That is, the comparison is made on the position of the statement table, the position of the cell, and the position of the ruled line (condition 3).

In step S55-5, the document correction unit 19 determines whether the document layout matches between the identical document information and the input document, based on the condition 4. That is, the comparison is made on one or more of the number of rows, the number of paragraphs, or text information included in the rows (condition 4).

In step S55-6, the document correction unit 19 totals results of determining whether each data matches, and divides the total by the number of pieces of data subjected to the determination to calculate the degree of match.

### Increasing Accuracy of Identity Determination

To permit a shift in the print position, a particular position in the document data may be set as an anchor (reference point) in the position information comparison method for the character string, the statement table, and the like. For example, one of or an average of multiple positions where the title, the date, the total, and the client company name are located in the invoice or the like is set as the anchor. This allows the identity to be determined highly accurately when the print position is shifted but the relative position based on the reference (i.e., anchor) is identical.

To permit document data having the statement table with a variable number of rows, the position information in the identical document information and the input document may be determined based on the anchor set at a predetermined position in the statement table. For example, a position such as the upper right corner, the lower right corner, the upper left corner, the lower left corner, or the center of the statement table may be set as the anchor.

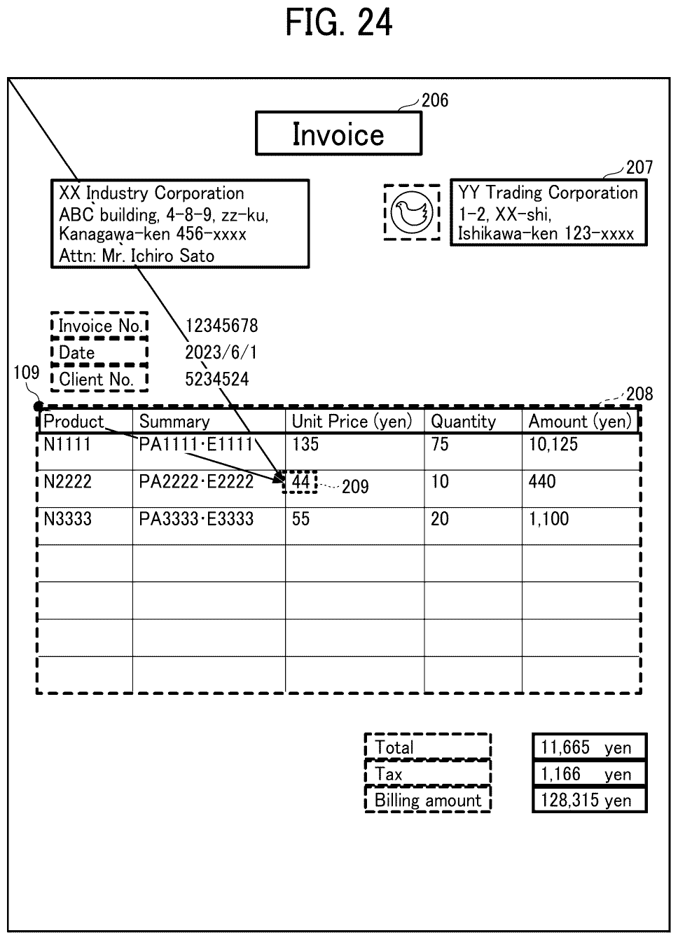

FIG. 24 is a diagram for describing an example of the relative position based on an anchor 109 set at a predetermined position in the statement table. When the predetermined position in the statement table is not set as the anchor 109, the coordinates of an item value 209 in the statement table are determined relative to the upper left corner of the invoice, for example. In contrast, when the predetermined position in the statement table (the upper left corner of the statement table in FIG. 24) is set as the anchor 109, the coordinates of the item value 209 in the statement table are determined relative to the reference point set at the upper left corner of the statement table, for example. When the predetermined position in the statement table is set as the anchor 109, the coordinates of the item value 209 based on the relative position are less likely to vary even when the print position of the statement table is shifted. This makes it easier to extract the item value 209.

Note that the ruled lines of the statement table are detectable as straight lines having a certain length or longer by the Hough transform or the like. Setting the predetermined position in the statement table as the anchor makes it easier to determine the identical document even when the statement table has a variable number of rows. This enables highly accurate determination of whether the input document is the identical document.

In the case of the statement table with no ruled lines, the statement table is detectable based on an overlap between character strings in the row and column directions, and the upper, lower, left, and right ends are determined. Any of these ends can be set as the anchor.

### Details of Correction

The correction in step S57 of FIG. 21 will be described next. When the input document and the identical document information are determined to be identical, the document correction unit 19 automatically corrects an incorrectly extracted character string based on the document correction history. Note that when a correction condition, which is prepared on assumption of the cases where the character string may be incorrectly extracted, is met, the document correction unit 19 makes a correction according to the met correction condition to suppress incorrect corrections.

The document correction history includes four pieces of data such as a character string before correction, a position of the character string before correction (hereinafter, referred to as the position before correction), a character string after correction, and a position of the character string after correction (hereinafter, referred to as the position after correction). The comparison targets include two pieces of data, which are a character string (hereinafter, referred to as a recognized character string) extracted from the input document by the character string extraction unit 14 and a position of the recognized character string.

The correction conditions will be described separately in eight cases below.
A. Cases where the item whose character string is to be extracted is constant regardless of the input document (such as the company name): cases 1 to 4
B. Cases where the item whose character string is to be extracted is variable depending on the input document (such as the date and the amount): cases 5 to 8

In the cases 1 to 8, a first image 251 (described below) is an image (an example of first document data) read at generation of the document correction history, and a second image 252 (described below) is an image (an example of second document data) generated by reading the input document.

When the correction conditions are met in the cases 1 to 4, the document correction unit 19 reads the character string from the position after correction, which is stored in the document correction history, in the second image 252, and replaces the recognized character string with this character string. Alternatively, the document correction unit 19 replaces the recognized character string with the character string after correction stored in the document correction history.

When the correction conditions are met in the cases 5 to 8, the document correction unit 19 reads the character string from the position after correction in the second image 252, and replaces the recognized character string with this character string.

### Cases 1 to 4

In the cases 1 to 4, the user has corrected the character string of the item “Client”. The recognized character string desirable in the second image 252 is “YY Trading Corporation”, and the position thereof is expressed as (x3, y3) and (x4, y4).

In the case 1, the position where character recognition was performed in the first image 251 was incorrect, and character recognition was performed at the same position in the second image 252, so that incorrect recognition has occurred.

FIGS. 25A and 25B are diagrams for describing an example of a character string correction based on a state corresponding to the case 1 and the correction conditions. The character string before correction (an example of a first character string), the position before correction, the character string after correction (an example of a second character string), the position after correction, the recognized character string (an example of a third character string), and the position of the recognized character string in the case 1 are as follows.

$$Character string before correction = XX Corporation$$

$$Position before correction = ( x 1 , y 1 ) ( x 2 , y 2 )$$

$$Character string after correction = YY Trading Corporation$$

$$Position after correction = ( x 3 , y 3 ) ( x 4 , y 4 )$$

$$Recognized character string = XX Corporation$$

$$Position of recognized character string = ( x 1 , y 1 ) ( x 2 , y 2 )$$

Correction conditions for detecting the case 1 are as follows.

A correction condition (1) is that the position before correction and the position of the recognized character string are identical. A correction condition (2) is that the character string before correction and the recognized character string are identical. Thus, the state illustrated in FIGS. 25A and 25B meets the correction conditions (1) and (2).

Note that the “positions being identical” does not necessarily request the complete match, and refers to a case where a difference between the position before correction and the position of the recognized character string is less than a threshold value. Whether the “character strings” are identical is also determined based on a predetermined criterion. That is, the character strings being identical does not necessarily require the complete match and permits a difference between the full width and the half width. When the character string of the input document includes the number of characters greater than or equal to a threshold value (e.g., 90%) of the character string of the identical document information, the character strings may be determined to be identical. The same applies to the correction conditions below.

In the case of the correction conditions (1) and (2), it can be determined with high probability that the same error as that occurred at character string extraction from the first image 251 has occurred at character string extraction from the second image 252.

The document correction unit 19 may make a correction when either one of the correction condition (1) or (2) is met. The correction conditions (1) and (2) may be combined, and the document correction unit 19 may make a correction when both the correction conditions (1) and (2) are met.

In the case 2, the position where character recognition was performed in the first image 251 is correct, and the position where character recognition was performed in the second image 252 is also correct but character recognition has failed.

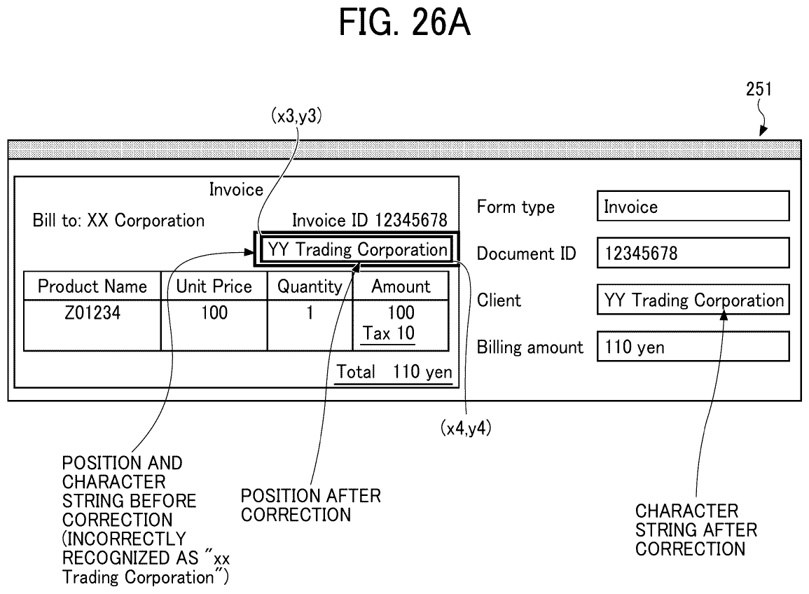

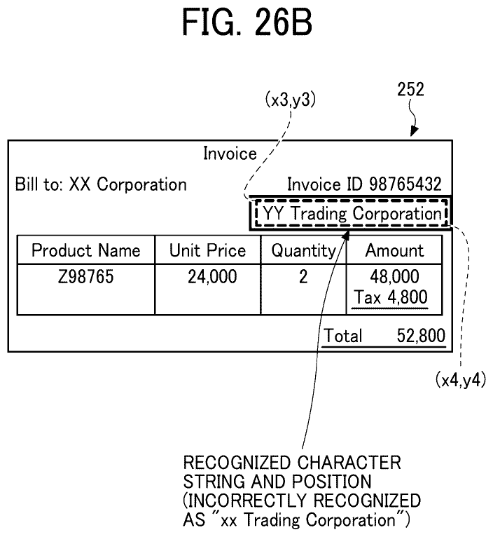

FIGS. 26A and 26B are diagrams for describing an example of a character string correction based on a state corresponding to the case 2 and the correction conditions. The character string before correction, the position before correction, the character string after correction, the position after correction, the recognized character string, and the position of the recognized character string in the case 2 are as follows.

$$Character string before correction = xx Trading Corporation$$

$$Position before correction = ( x 3 , y 3 ) ( x 4 , y 4 )$$

$$Character string after correction = YY Trading Corporation$$

$$Position after correction = ( x 3 , y 3 ) ( x 4 , y 4 )$$

$$Recognized character string = xx Trading Corporation$$

$$Position of recognized character string = ( x 3 , y 3 ) ( x 4 , y 4 )$$

Correction conditions for detecting the case 2 are as follows.

A correction condition (1) is that the position before correction and the position of the recognized character string are identical.

A correction condition (2) is that the character string before correction and the recognized character string are identical based on a predetermined criterion.

A correction condition (3) is that the position after correction and the position of the recognized character string are identical.

A correction condition (4) is that the character string after correction and the recognized character string are identical based on a predetermined criterion.

Thus, the state illustrated in FIGS. 26A and 26B meets the correction conditions (1) to (4).

Note that whether character recognition has failed is unclear when the correction condition (3) alone is met. Whether character recognition has failed is unclear when the correction condition (4) alone is met. However, by making a correction when the correction condition (3) or (4) is met, the error can be corrected when it is probable that character recognition has failed.

The document correction unit 19 may make a correction when any one of the correction conditions (1) to (4) is met. Two or more of the correction conditions (1) to (4) may be combined, and the document correction unit 19 may make a correction when the two or more correction conditions are met.

In the case 3, the position where character recognition was performed in the first image 251 is incorrect, and the position where character recognition was performed in the second image 252 is correct.

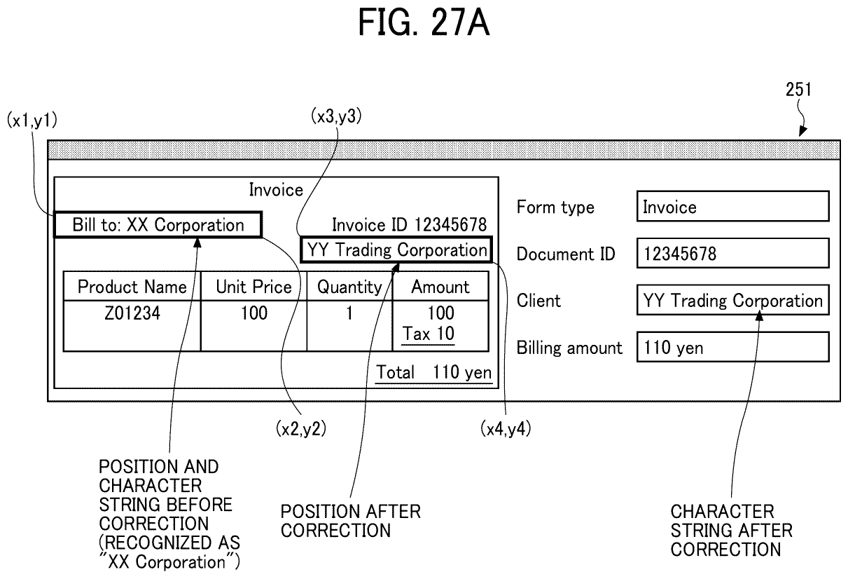

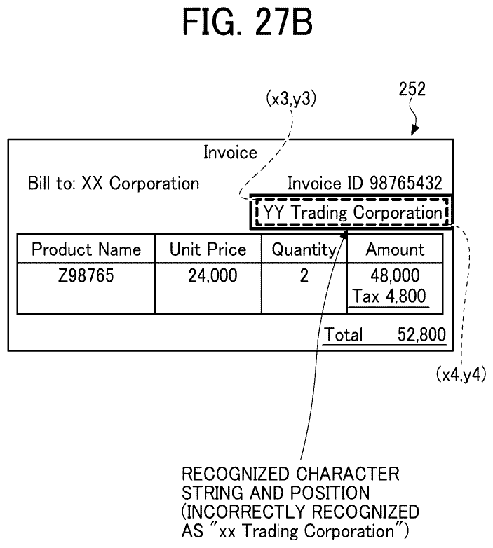

FIGS. 27A and 27B are diagrams for describing an example of a character string correction based on a state corresponding to the case 3 and the correction conditions. The character string before correction, the position before correction, the character string after correction, the position after correction, the recognized character string, and the position of the recognized character string in the case 3 are as follows.

$$Character string before correction = XX Corporation$$

$$Position before correction = ( x 1 , y 1 ) ( x 2 , y 2 )$$

$$Character string after correction = YY Trading Corporation$$

$$Position after correction = ( x 3 , y 3 ) ( x 4 , y 4 )$$

$$Recognized character string = xx Trading Corporation$$

$$Position of recognized character string = ( x 3 , y 3 ) ( x 4 , y 4 )$$

Correction conditions for detecting the case 3 are as follows.

A correction condition (3) is that the position after correction and the position of the recognized character string are identical.

A correction condition (4) is that the character string after correction and the recognized character string are identical.

Thus, the state illustrated in FIGS. 27A and 27B meets the correction conditions (3) and (4).

Note that whether incorrect recognition has occurred is unclear when the correction condition (3) alone is met. Whether incorrect recognition has occurred is unclear when the correction condition (4) alone is met. However, by making a correction when the correction condition (3) or (4) is met, the error can be corrected when incorrect recognition is probable.

The document correction unit 19 may make a correction when either one of the correction condition (3) or (4) is met. The correction conditions (3) and (4) may be combined, and the document correction unit 19 may make a correction when both the correction conditions (3) and (4) are met.

In the case 4, the character string was incorrectly recognized in the first image 251, and incorrect recognition has occurred because the position is incorrect in the second image 252.

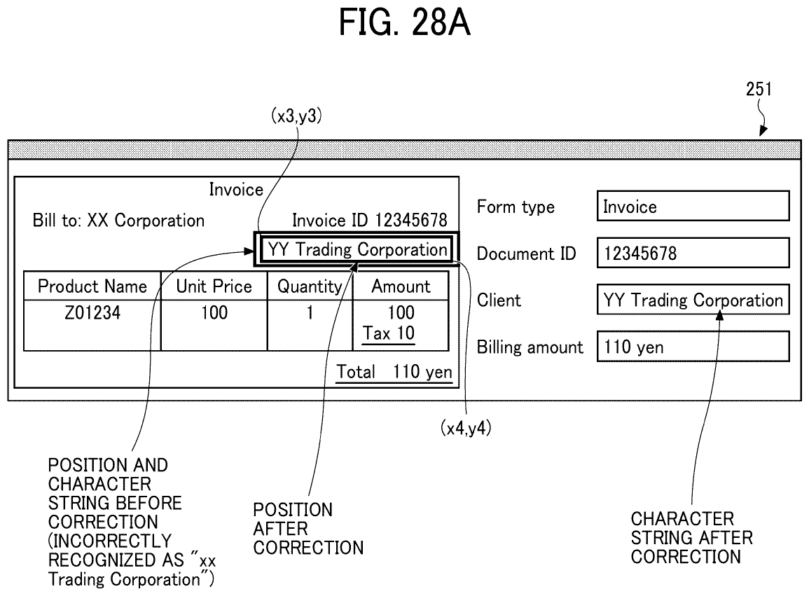

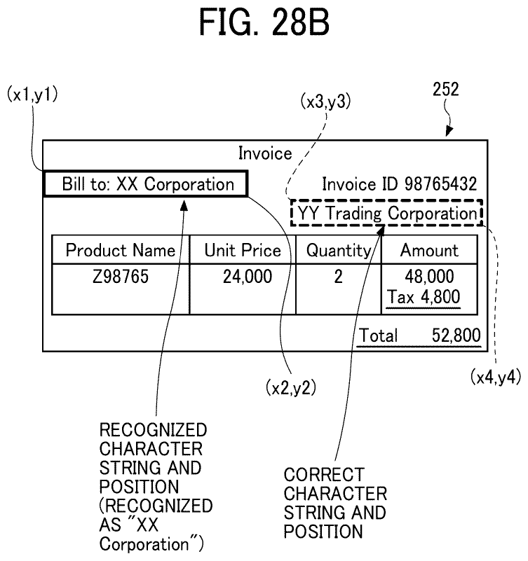

FIGS. 28A and 28B are diagrams for describing an example of a character string correction based on a state corresponding to the case 4 and the correction conditions. The character string before correction, the position before correction, the character string after correction, the position after correction, the recognized character string, and the position of the recognized character string in the case 4 are as follows.

$$Character string before correction = xx Trading Corporation$$

$$Position before correction = ( x 3 , y 3 ) ( x 4 , y 4 )$$

$$Character string after correction = YY Trading Corporation$$

$$Position after correction = ( x 3 , y 3 ) ( x 4 , y 4 )$$

$$Recognized character string = XX Trading Corporation$$

$$Position of recognized character string = ( x 1 , y 1 ) ( x 2 , y 2 )$$

Correction conditions for detecting the case 4 are as follows.

A correction condition (5) is that characters are present at the position after correction in the second image 252.

A correction condition (6) is that the character string after correction is present in the second image 252.

Thus, the state illustrated in FIGS. 28A and 28B meets the correction conditions (5) and (6).

Note that whether incorrect recognition has occurred is unclear when the correction condition (5) alone is met. Whether incorrect recognition has occurred is unclear when the correction condition (6) alone is met. However, by making a correction when the correction condition (5) or (6) is met, the error can be corrected when incorrect recognition is probable.

The document correction unit 19 may make a correction when either one of the correction condition (5) or (6) is met. The correction conditions (5) and (6) may be combined, and the document correction unit 19 may make a correction when both the correction conditions (5) and (6) are met.

### Cases 5 to 8

In the cases 5 to 8, the user has corrected the character string of the item “Billing date”. The recognized character string desirable in the second image 252 is “1/10/2023”, and the position thereof is defined as (x8, y8) and (x9, y9).

In the case 5, the position where character recognition was performed in the first image 251 is incorrect, and character recognition was performed at the same position in the second image 252, so that incorrect recognition has occurred.

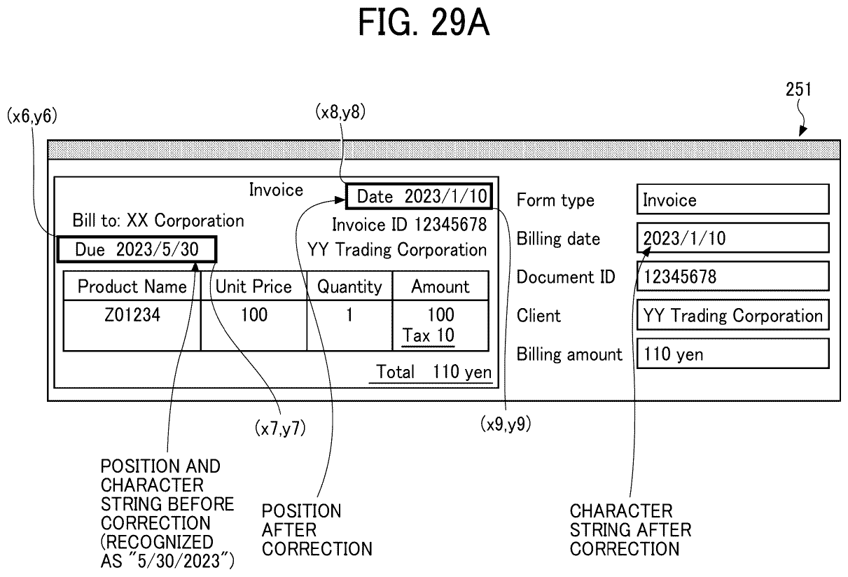

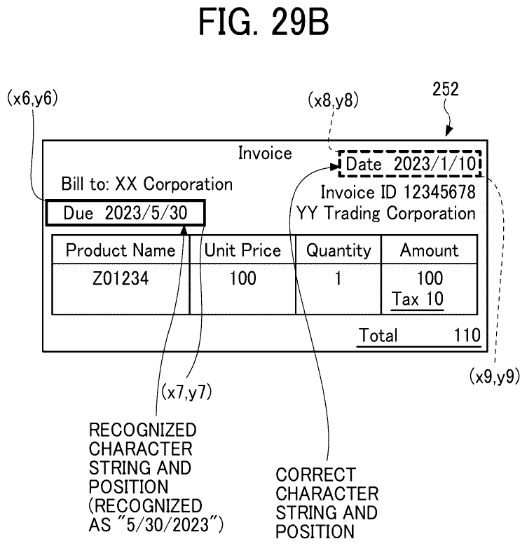

FIGS. 29A and 29B are diagrams for describing an example of a character string correction based on a state corresponding to the case 5 and the correction conditions. The character string before correction, the position before correction, the character string after correction, the position after correction, the recognized character string, the position of the recognized character string, the attribute of the character string before correction, and the attribute of the recognized character string in the case 5 are as follows.

$$Character string before correction = 5 / 30 / 2023$$

$$Position before correction = ( x 6 , y 6 ) ( x 7 , y 7 )$$

$$Character string after correction = 1 / 10 / 2023$$

$$Position after correction = ( x 8 , y 8 ) ( x 9 , y 9 )$$

$$Recognized character string = 5 / 30 / 2023$$

$$Position of recognized character string = ( x 6 , y 6 ) ( x 7 , y 7 )$$

$$Attribute of character string before correction = Date$$

$$Attribute of recognized character string = Date$$

Correction conditions for detecting the case 5 are as follows.

A correction condition (7) is that the position before correction and the position of the recognized character string are identical.

A correction condition (8) is that the attribute of the character string before correction and the attribute of the recognized character string are identical.

Thus, the state illustrated in FIGS. 29A and 29B meets the correction conditions (7) and (8).

When the correction condition (7) is met, it is determined with high probability that the same error as that occurred at character string extraction from the first image 251 has occurred at character string extraction from the second image 252. Whether incorrect recognition has occurred is unclear when the correction condition (8) alone is met. However, by making a correction when the correction condition (8) is met, the error can be corrected when incorrect recognition is probable.

Note that the attribute refers to a predetermined format, such as xxxx/xx/xx or xx/xx/xxxx in the case of the date or ¥xx,xxx in the case of the amount.

The document correction unit 19 may make a correction when either one of the correction condition (7) or (8) is met. The correction conditions (7) and (8) may be combined, and the document correction unit 19 may make a correction when both the correction conditions (7) and (8) are met.

In the case 6, the position where character recognition was performed in the first image 251 is correct, and the position where character recognition was performed in the second image 252 is also correct but character recognition has failed.

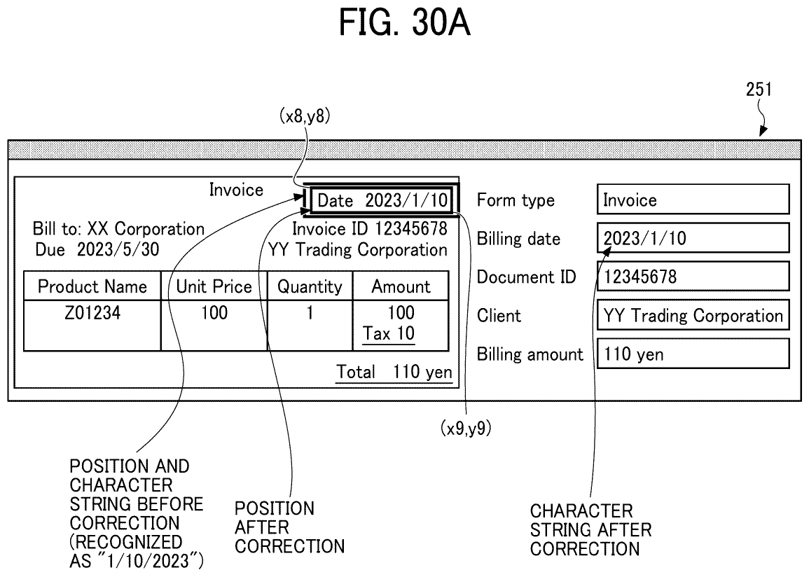

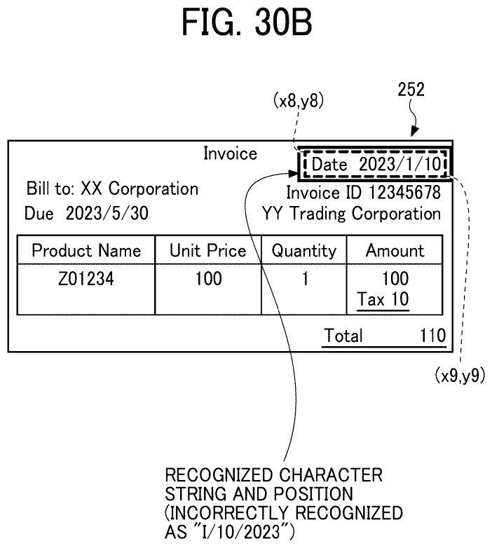

FIGS. 30A and 30B are diagrams for describing an example of a character string correction based on a state corresponding to the case 6 and the correction conditions. The character string before correction, the position before correction, the character string after correction, the position after correction, the recognized character string, the position of the recognized character string, the attribute of the character string before correction, the attribute of the character string after correction, and the attribute of the recognized character string in the case 6 are as follows.

$$Character string before correction = 1 / 10 / 2023$$

$$Position before correction = ( x 8 , y 8 ) ( x 9 , y 9 )$$

$$Character string after correction = 1 / 10 / 2023$$

$$Position after correction = ( x 8 , y 8 ) ( x 9 , y 9 )$$

$$Recognized character string = I / 10 / 2023 ( numeral “ 1 ” is incorrectly recognized as the upper - case alphabet “ I ” )$$

$$Position of recognized character string = ( x 8 , y 8 ) ( x 9 , y 9 )$$

$$Attribute of character string before correction = Date$$

$$Attribute of character string after correction = Date$$

$$Attribute of recognized character string = Date$$

Correction conditions for detecting the case 6 are as follows.

A correction condition (7) is that the position before correction and the position of the recognized character string are identical.

A correction condition (8) is that the attribute of the character string before correction and the attribute of the recognized character string are identical.

A correction condition (9) is that the position after correction and the position of the recognized character string are identical.

A correction condition (10) is that the attribute of the character string after correction and the attribute of the recognized character string are identical.

Thus, the state illustrated in FIGS. 30A and 30B meets the correction conditions (7) to (10).

Note that whether incorrect recognition has occurred is unclear when the correction condition (9) alone is met. Whether incorrect recognition has occurred is unclear when the correction condition (10) alone is met. However, by making a correction when the correction condition (9) or (10) is met, the error can be corrected when incorrect recognition is probable.

The document correction unit 19 may make a correction when any one of the correction conditions (7) to (10) is met. Two or more of the correction conditions (7) to (10) may be combined, and the document correction unit 19 may make a correction when the two or more correction conditions are met.

In the case 7, the position where character recognition was performed in the first image 251 is incorrect, and the position where character recognition was performed in the second image 252 is correct.

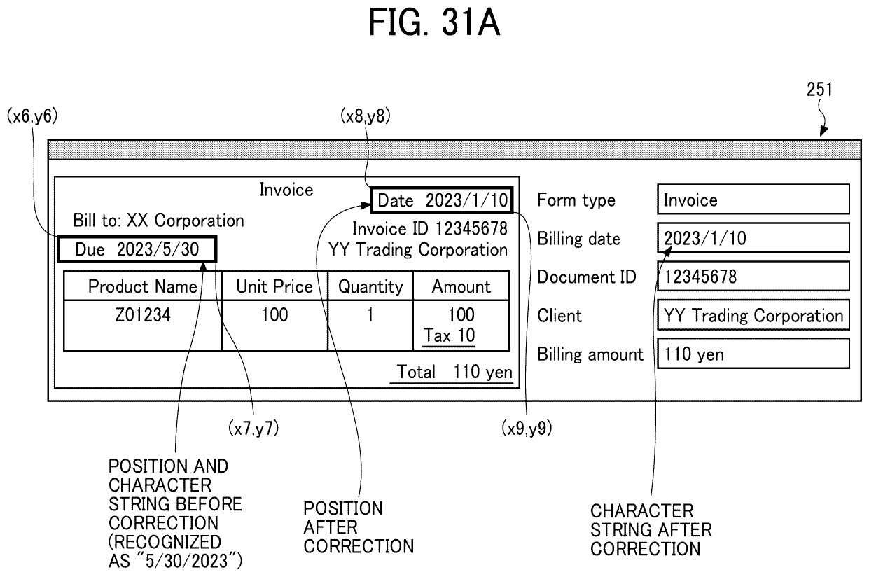

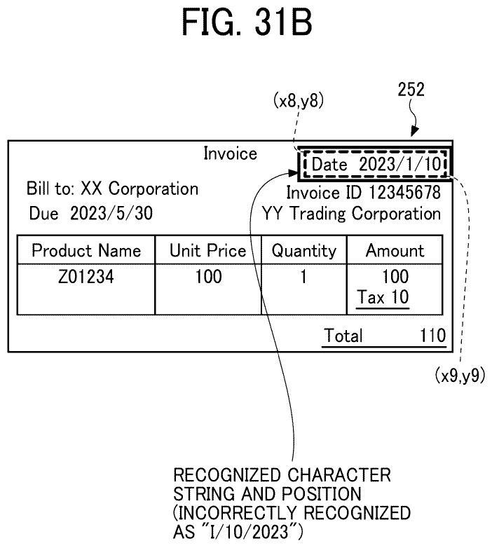

FIGS. 31A and 31B are diagrams for describing an example of a character string correction based on a state corresponding to the case 7 and the correction conditions. The character string before correction, the position before correction, the character string after correction, the position after correction, the recognized character string, the position of the recognized character string, the attribute of the character string after correction, and the attribute of the recognized character string in the case 7 are as follows.

$$Character string before correction = 5 / 30 / 2023$$

$$Position before correction = ( x 6 , y 6 ) ( x 7 , y 7 )$$

$$Character string after correction = 1 / 10 / 2023$$

$$Position after correction = ( x 8 , y 8 ) ( x 9 , y 9 )$$

$$Recognized character string = I / 10 / 2023 ( numeral “ 1 ” is incorrectly recognized as the upper - case alphabet “ I ” )$$

$$Position of recognized character string = ( x 8 , y 8 ) ( x 9 , y 9 )$$

$$Attribute of character string after correction = Date$$

$$Attribute of recognized character string = Date$$

Correction conditions for detecting the case 7 are as follows.

A correction condition (9) is that the position after correction and the position of the recognized character string are identical.

A correction condition (10) is that the attribute of the character string after correction and the attribute of the recognized character string are identical.

Thus, the state illustrated in FIGS. 31A and 31B meets the correction conditions (9) and (10).

Note that whether incorrect recognition has occurred is unclear when the correction condition (9) alone is met. Whether incorrect recognition has occurred is unclear when the correction condition (10) alone is met. However, by making a correction when the correction condition (9) or (10) is met, the error can be corrected when incorrect recognition is probable.

The document correction unit 19 may make a correction when either the correction condition (9) or the correction condition (10) is met. The correction conditions (9) and (10) may be combined, and the document correction unit 19 may make a correction when both the correction conditions (9) and (10) are met.

In the case 8, the character was incorrectly recognized in the first image 251, and incorrect recognition has occurred because the position is incorrect in the second image 252.

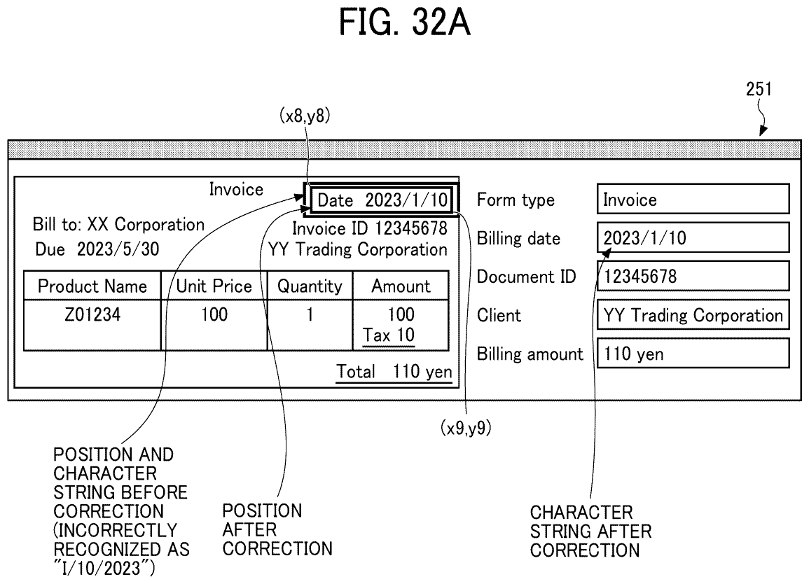

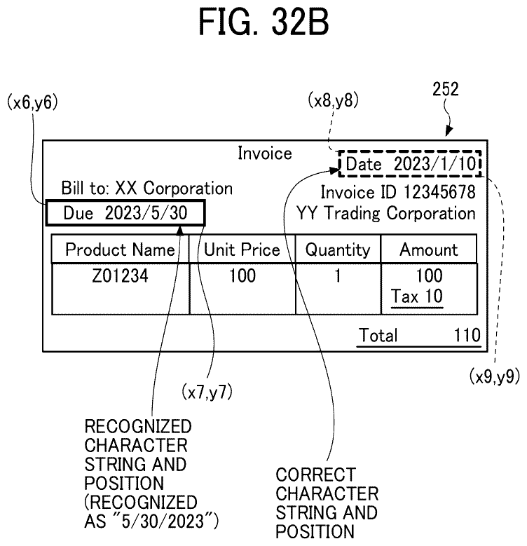

FIGS. 32A and 32B are diagrams for describing an example of a character string correction based on a state corresponding to the case 8 and the correction conditions. The character string before correction, the position before correction, the character string after correction, the position after correction, the recognized character string, the position of the recognized character string, and the attribute of the character string after correction in the case 8 are as follows.

$$Character string before correction = I / 10 / 2023 ( numeral “ 1 ” is incorrectly recognized as the upper - case alphabet “ I ” )$$

$$Position before correction = ( x 8 , y 8 ) ( x 9 , y 9 )$$

$$Character string after correction = 1 / 10 / 2023$$

$$Position after correction = ( x 8 , y 8 ) ( x 9 , y 9 )$$

$$Recognized character string = 5 / 30 / 2023$$

$$Position of recognized character string = ( x 6 , y 6 ) ( x 7 , y 7 )$$

$$Attribute of character string after correction = Date$$

Correction conditions for detecting the case 8 are as follows.

A correction condition (11) is that characters are present at the position after correction in the second image 252.

A correction condition (12) is that the character string having the same attribute as the attribute of the character string after correction is present in the second image 252.

Thus, the state illustrated in FIGS. 32A and 32B meets the correction conditions (11) and (12).

Note that whether incorrect recognition has occurred is unclear when the correction condition (11) alone is met. Whether incorrect recognition has occurred is unclear when the correction condition (12) alone is met. However, by making a correction when the correction condition (11) or (12) is met, the error can be corrected when incorrect recognition is probable.

The document correction unit 19 may make a correction when either the correction condition (11) or the correction condition (12) is met. The correction conditions (11) and (12) may be combined, and the document correction unit 19 may make a correction when both the correction conditions (11) and (12) are met.

### Automatic Updating of Training Data in Response to Change of Engine

Automatic deletion of the training data will be described next. The document learning unit 18 automatically deletes the training data when various engines are changed to gain the ability to correctly recognize the identical document (extract the intended character string). When the identical document fails to be correctly recognized, the document learning unit 18 updates the training data.

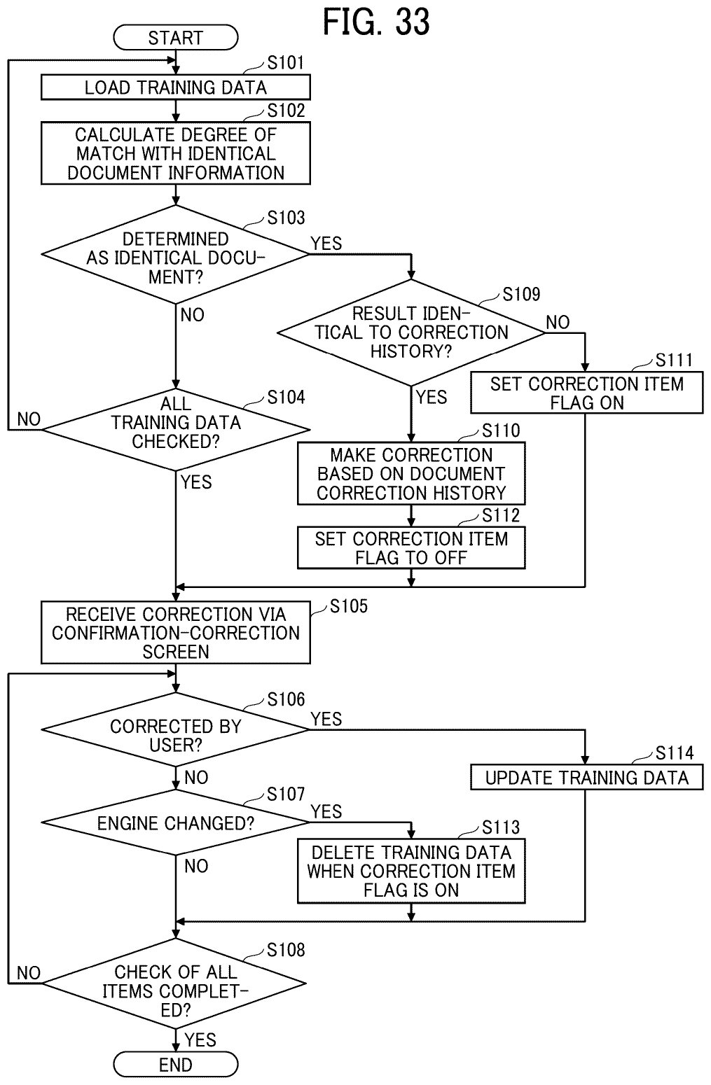

FIG. 33 is a flowchart of an example of automatically updating training data in response to a change of the engine. The process in FIG. 33 is performed, for example, when the engine is changed or the user corrects the extraction result.

In step S101, the document learning unit 18 loads the training data.

In step S102, the document learning unit 18 calculates a degree of match between the identical document information and the input document. The degree-of-match calculation method is the same as that in FIG. 21.

In step S103, the document learning unit 18 compares the degree of match with a threshold value to determine whether the input document can be determined as the identical document. When the degree of match is greater than or equal to the threshold value, the document learning unit 18 determines that the input document is the identical document. When the determination in step S103 is Yes, the process proceeds to step S109. When the determination in step S103 is No, the process proceeds to step S104.

In step S104, the document learning unit 18 determines whether all the training data has been checked. When the determination in step S104 is Yes, the process proceeds to step S105. When the determination in step S104 is No, the process returns to step S101.

In step S109, the document learning unit 18 determines whether the extraction result obtained from the input document this time is identical to that of the document correction history. This determination may be made using the same determination used in one or more of the cases 1 to 8.

When the determination in step S109 is Yes, the process proceeds to step S110. When the determination in step S109 is No, the process proceeds to step S111.

In step S110, the document correction unit 19 corrects the extraction result, based on the document correction history. In step S112, the document correction unit 19 sets a correction item flag to OFF. The correction item flag indicates whether a correction has been made based on the document correction history (OFF: corrected, ON: not corrected).

In step S111, the document learning unit 18 sets the correction item flag to ON since the document correction unit 19 has not made a correction based on the document correction history.

In step S105, the display control unit 16 causes the confirmation-correction screen 230 to be displayed. In step S105, the user corrects the extraction result as desired.

In step S106, the document learning unit 18 determines whether the user has corrected the extraction result, based on the correction item flag. When the determination in step S106 is Yes, the process proceeds to step S114. When the determination in step S106 is No, the process proceeds to step S107.

In step S114, the document learning unit 18 updates the training data since the user has corrected the extraction result. That is, since the user has corrected the extraction result, the training data (the identical document information, the document correction history, and engine specifying information) is to be updated regardless of whether the engine is changed. In step S107, the document learning unit 18 determines whether one or more engines have been changed. It is determined whether the engine has been changed, based on comparison between the engine specifying information and current engine information. The change of the engine may include at least one of version-up, version-down, or replacement of the engine. Note that the engine specifying information is updated to the current engine information after this processing. When the determination in step S107 is Yes, the process proceeds to step S113. When the determination in step S107 is No, the process proceeds to step S108.

In step S113, the document learning unit 18 deletes the training data when the correction item flag is ON. Specifically, it is inferred that No is determined in step S109 because of the change of the engine. Since the user does not make a correction, it is determined that the new engine has improved performance and the old training data is no longer effective. Thus, the document learning unit 18 deletes the training data. When the correction item flag is OFF, Yes is determined in step S109. Thus, it is determined that the old training data is effective even when the engine is changed. Therefore, the training data is not to be deleted.

In step S108, the document learning unit 18 determines whether check of all the items is completed. When the determination in step S108 is Yes, the process of FIG. 33 ends. When the determination in step S108 is No, the process returns to step S106.

As described above, the character string extraction apparatus 2 can suppress incorrect correction of a character string extracted from document data.

When the input document is determined as the identical document, the character string extraction apparatus 2 further assumes cases where the character string is incorrectly extracted. The character string extraction apparatus 2 determines whether a correction condition prepared for each of the cases is met. When the correction condition is met, the character string extraction apparatus 2 makes a correction using a correction method corresponding to the correction condition. This allows the character string extraction apparatus 2 to suppress incorrect correction when a correction is made based on the document correction history. This also allows the character string extraction apparatus 2 to make a correction when failing to correctly extract the character string due to the same error for which the correction history is registered.

When training data of diverse documents is automatically generated, the item corrected by the user is reflected in the training data. This can reduce the size of the training data and reduce the time to determine whether the input document is the identical document.

When a statement table is present, a predetermined position in the statement table is set as an anchor. The character string is extracted based on a relative position from the anchor. This makes it possible to determine whether the input document is the identical document with high accuracy.

When the engine is changed, the training data is automatically deleted. This allows appropriate training data to be always associated with the engine.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, the correction conditions (1) to (12) for the cases 1 to 8 have been described in the embodiments. Two or more of the correction conditions (1) to (12) may be combined in any manner.

A server apparatus may perform the processes described in the present embodiment. In this case, the terminal apparatus 3 and the character string extraction apparatus 2, which is the server apparatus, communicate with each other via a network. The terminal apparatus 3 executes a web app. The terminal apparatus 3 transmits document data of a form to the character string extraction apparatus 2 via the web app. Then, the character string extraction apparatus 2 extracts character strings, and transmits the extraction result to the terminal apparatus 3. The character string extraction apparatus 2, which is the server apparatus, does not necessarily perform all the processes from character recognition to document learning. Instead, the terminal apparatus 3 may perform part of the processes by the web app.

The configuration examples in FIG. 6 and other figures are obtained by dividing the processes performed by the character string extraction apparatus 2 according to major functions for ease of understanding. No limitation on the present disclosure is intended by how the processes are divided into processing units or by the name of the processing units. The processes performed by the character string extraction apparatus 2 may be divided into more processing units according to the processing content. In addition, the division may be performed so that one processing unit contains more processing.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure provides significant improvements in computer capabilities and functionalities. These improvements allow a user to utilize a computer which provides for more efficient and robust interaction with a table which is a way to store and present information in an information processing apparatus. Moreover, the present disclosure provides for a better user experience through the use of a more efficient, powerful and robust user interface. Such a user interface provides for a better interaction between a human and a machine.

According to Aspect 1, an information processing apparatus for extracting a character string from document data includes an operation receiving unit, a document learning unit, an acquisition unit, a character string extraction unit, an identical document determination unit, and a document correction unit. The operation receiving unit receives a correction on a character string extracted from first document data. The document learning unit stores a character string that is incorrectly recognized and correction content as a document correction history, and stores identical document information including the character string of the first document data and position information of the first document data. The acquisition unit acquires second document data of an input document. The character string extraction unit extracts a character string from the second document data acquired by the acquisition unit. The identical document determination unit calculates a degree of match, based on the character string or position information of the second document data acquired by the acquisition unit and the character string or the position information of the identical document information. The document correction unit corrects the character string extracted by the character string extraction unit, based on the correction content, when the degree of match is greater than or equal to a threshold value and a comparison result between the character string extracted by the character string extraction unit and the document correction history meets a predetermined condition.

According to Aspect 2, in the information processing apparatus of Aspect 1, the operation receiving unit receives a correction on a first character string to a second character string or a correction on position information of the first character string to position information of the second character string, the first character string being extracted as data of the first document data. The document learning unit stores, as the document correction history, any one of the first character string before correction, the position information of the first character string before correction, the second character string after correction received by the operation receiving unit, and the position information of the second character string after correction received by the operation receiving unit. The document learning unit stores, as the identical document information, the first character string that is extracted as the data of the first document data or the position information of the first character string. The character string extraction unit extracts a third character string or position information of the third character string from the second document data acquired by the acquisition unit. The identical document determination unit calculates the degree of match, based on at least one of a comparison result between the third character string and the first character string of the identical document information or a comparison result between the position information of the third character string and the position information of the first character string of the identical document information. The predetermined condition includes a case where the character string extraction unit has extracted the third character string that is constant regardless of the input document and where at least one of cases is met. The cases include a case where a difference between the position information of the first character string and the position information of the third character string is less than a threshold value, a case where the first character string and the third character string are determined to be identical based on a predetermined criterion, a case where a difference between the position information of the second character string and the position information of the third character string is less than a threshold value, a case where the second character string and the third character string are determined to be identical based on a predetermined criterion, a case where a character string is present at a position indicated by the position information of the second character string in the second document data, and a case where the second character string is present in the second document data. The document correction unit corrects, based on the document correction history, the third character string extracted by the character string extraction unit.

According to Aspect 3, in the information processing apparatus of Aspect 1, the operation receiving unit receives a correction on a first character string to a second character string or a correction on position information of the first character string to position information of the second character string, the first character string being extracted as data of the first document data. The document learning unit stores, as the document correction history, the first character string before correction or the position information of the first character string before correction, or stores, as the document correction history, the second character string after correction received by the operation receiving unit or the position information of the second character string after correction received by the operation receiving unit. The document learning unit stores, as the identical document information, the first character string that is extracted as the data of the first document data or the position information of the first character string. The character string extraction unit extracts a third character string or position information of the third character string from the second document data acquired by the acquisition unit. The identical document determination unit calculates the degree of match, based on at least one of a comparison result between the third character string and the first character string of the identical document information or a comparison result between the position information of the third character string and the position information of the first character string of the identical document information. The predetermined condition includes a case where the character string extraction unit has extracted the third character string that is variable depending on the input document and where at least one of cases is met. The cases include a case where a difference between the position information of the first character string and the position information of the third character string is less than a threshold value, a case where an attribute of the first character string and an attribute of the third character string are identical, a case where a difference between the position information of the second character string and the position information of the third character string is less than a threshold value, a case where an attribute of the second character string and the attribute of the third character string are identical, a case where a character string is present at a position indicated by the position information of the second character string in the second document data, and a case where the second character string is present in the second document data. The document correction unit corrects, based on the document correction history, the third character string extracted by the character string extraction unit.

According to Aspect 4, in the information processing apparatus of Aspect 2, the document correction unit replaces the third character string with the second character string. Alternatively, the document correction unit replaces the third character string with the character string extracted from the position indicated by the position information of the second character string in the second document data.

According to Aspect 5, in the information processing apparatus of Aspect 3, the document correction unit replaces the third character string with the character string extracted from the position indicated by the position information of the second character string in the second document data.

According to Aspect 6, in the information processing apparatus of Aspect 2, the document learning unit stores, as the document correction history, the first character string, the position information of the first character string, the second character string, and the position information of the second character string only when the operation receiving unit receives the correction on the first character string to the second character string and the correction on the position information of the first character string to the position information of the second character string.

According to Aspect 7, in the information processing apparatus of any one of Aspects 2 to 6, the document learning unit stores, as the identical document information, the first character string, the position information of the first character string, and one or more of a table layout in the first document data, a number of rows or paragraphs in the first document data, or text information contained in the rows or the paragraphs. The identical document determination unit calculates the degree of match, based on at least one of a comparison result between the third character string and the first character string of the identical document information, a comparison result between the position information of the third character string and the position information of the first character string of the identical document information, a comparison result between the table layout in the first document data and a table layout in the second document data, a comparison result between the number of rows or paragraphs in the first document data and a number of rows or paragraphs in the second document data, or a comparison result between the text information in the first document data and text information in the second document data.

According to Aspect 8, in the information processing apparatus of Aspect 2, the identical document information has, for each data extracted by the character string extraction unit, a setting of whether to store the first character string or the position information of the first character string. The identical document determination unit only uses the first character string for which the identical document information has the setting to store, to perform a comparison between the third character string and the first character string. Alternatively, the identical document determination unit only uses the position information of the first character string for which the identical document information has the setting to store, to perform a comparison between the position information of the third character string and the position information of the first character string. Alternatively, as for a table layout in the first document data for which the identical document information has the setting to store and a table layout in the second document data, the identical document determination unit only performs a comparison between position information of the table layout in the first document data and position information of the table layout in the second document data. Alternatively, as for a number of rows or paragraphs in the first document data for which the identical document information has the setting to store and a number of rows or paragraphs in the second document data, the identical document determination unit performs a comparison between a count based on position information of the rows or paragraphs in the first document data and a count based on position information of the rows or paragraphs in the second document data. Alternatively, the identical document determination unit performs a comparison between text information contained in the rows or paragraphs in the first document data for which the identical document information has the setting to store and text information in the second document data. The identical document determination unit calculates the degree of match, based on a result of at least one of the comparisons.

According to Aspect 9, in the information processing apparatus of Aspect 2, when a table is detected from the second document data acquired by the acquisition unit, the identical document determination unit uses position information of the first character string relative to a reference point set in a table in the first document data or position information of the third character string relative to a reference point set in the table in the second document data to compare the position information of the third character string with the position information of the first character string.

According to Aspect 10, in the information processing apparatus of Aspect 2, when a document type or a company name from the third character string extracted as data by the character string extraction unit is identical to a document type or a company name included as the first character string in the identical document information, the identical document determination unit performs at least one comparison of: a comparison between the third character string and the first character string that are other than the document type or the company name; a comparison between the position information of the third character string and the position information of the first character string, the third character string and the first character string being other than the document type or the company name; a comparison between a table layout in the first document data and a table layout in the second document data; a comparison between a number of rows or paragraphs in the first document data and a number of rows or paragraphs in the second document data; or a comparison between text information contained in the rows or paragraphs in the first document data and text information in the second document data. The identical document determination unit calculates the degree of match, based on a result of the at least one comparison.

According to Aspect 11, in the information processing apparatus of Aspect 2, the information processing apparatus uses one or more engines to extract the third character string or the position information of the third character string. The one or more engines are for extracting a character string from the document data. In response to a change of at least one engine among the one or more engines, the document learning unit deletes the identical document information and the document correction history, when the document correction unit corrects neither the third character string nor the position information of the third character string based on the document correction history and the operation receiving unit receives neither a correction on the third character string to the second character string nor a correction on the position information of the third character string to the position information of the second character string.

According to Aspect 12, in the information processing apparatus of Aspect 11, regardless of whether at least one engine among the one or more engines is changed, when the operation receiving unit receives the correction on the third character string to the second character string and the correction on the position information of the third character string to the position information of the second character string, the document learning unit updates the document correction history with the second character string after correction received by the operation receiving unit and the position information of the second character string after correction received by the operation receiving unit.

According to Aspect 13, a correction method to be performed by an information processing apparatus for extracting a character string from document data, the correction method includes: receiving a correction on a character string extracted from first document data; storing a character string that is incorrectly recognized and correction content as document correction history, and storing identical document information including the character string and position information of the first document data; acquiring second document data of an input document; extracting a character string from the acquired second document data; calculating a degree of match, based on the character string or position information of the acquired second document data and the character string or the position information of the identical document information; and correcting the character string extracted from the second document data, based on the correction content, when the degree of match is greater than or equal to a threshold value and a comparison result between the character string extracted from the second document data and the document correction history meets a predetermined condition.

1. An information processing apparatus comprising
circuitry configured to:
receive correction content indicating a change from a first character string extracted from first document data to a second character string;
store, in a memory, a document correction history representing the correction content of the first document data, and identical document information used for determining whether an input document has an identical format with the first document data;
acquire second document data as the input document;
extract a third character string from the second document data;
calculate a degree of match between the second document data and the identical document information; and
when the degree of match is equal to or greater than a threshold value, and a comparison result between the third character string of the second document data and the document correction history meets a predetermined condition, correct the third character string of the second document data based on the correction content represented by the document correction history.

2. The information processing apparatus according to claim 1, wherein
the identical document information sets, for each of one or more types of character strings included in the first document data, whether one of or both of the character string and position information of the character string is to be stored,
the circuitry determines the third character string to be extracted from the second document data, using at least one of the character string or the position information of the character string that is stored based on the setting of the identical document information, and
calculates the degree of match between the second document data and the identical document information.

3. The information processing apparatus according to claim 2, wherein
the identical document information sets to store the character string and the position information of the character string, when the character string does not vary according to the input document, and
the identical document information sets to store only the position information of the character string, when the character string varies according to the input document.

4. The information processing apparatus according to claim 2, wherein
the first document further includes at least one of a table layout or a document layout, and
the identical document information sets to store position information of the at least one of the table layout or the document layout.

5. The information processing apparatus according to claim 2, wherein
when the third character string varies according to the input document,
the circuitry replaces the third character string, with a character string extracted using position information of the second character string of the second document data.

6. The information processing apparatus according to claim 2, wherein
when the third character string does not vary according to the input document,
the circuitry replaces the third character string with one of the second character string and a character string extracted using position information of the second character string of the second document data.

7. The information processing apparatus according to claim 2, wherein, when the third character string does not vary according to the input document,
the predetermined condition includes at least one of:
a case where a difference between position information of the first character string and position information of the third character string is less than a threshold value;
a case where the first character string is determined to be identical to the third character string;
a case where a difference between position information of the second character string and the position information of the third character string is less than a threshold value;
a case where the second character string is determined to be identical to the third character string based on a predetermined criterion;
a case where a character string is present at a position indicated by the position information of the second character string in the second document data; or
a case where the second character string is present in the second document data.

8. The information processing apparatus according to claim 2, wherein, when the third character string varies according to the input document, the predetermined condition includes at least one of:
a case where a difference between position information of the first character string and position information of the third character string is less than a threshold value;
a case where an attribute of the first character string is identical to an attribute of the third character string;
a case where a difference between position information of the second character string and the position information of the third character string is less than a threshold value;
a case where an attribute of the second character string is identical to an attribute of the third character string;
a case where a character string is present at a position indicated by the position information of the second character string in the second document data; or
a case where the second character string is present in the second document data.

9. The information processing apparatus according to claim 2, wherein, when a table is detected from the second document data, the circuitry is configured to
determine position information of the first character string relative to a reference point set in the table in the first document data, or position information of the third character string relative to a reference point set in the table in the second document data, and
compare the position information of the third character string with the position information of the first character string.

10. The information processing apparatus according to claim 2, wherein, when at least one of a document type or a company name included in the third character string is identical to corresponding one of a document type or a company name included in the first character string indicated by the identical document information,
the circuitry is configured to compare the at least one of the document type or the company name to generate a comparison result, and calculate the degree of match based on the comparison result.

11. The information processing apparatus according to claim 2, wherein the circuitry is configured to
extract the third character string using one or more engines, and
when at least one of the one or more engines is changed, delete the identical document information and the document correction history.

12. The information processing apparatus according to claim 3, wherein
the character string that does not vary according to the input document includes an item name, and
the character string that varies according to the input document includes an item value.

13. A correcting method comprising:
receiving correction content indicating a change from a first character string extracted from first document data to a second character string;
storing, in a memory, a document correction history representing the correction content of the first document data, and identical document information used for determining whether an input document has an identical format with the first document data;
acquiring second document data as the input document;
extracting a third character string from the second document data;
calculating a degree of match between the second document data and the identical document information; and
when the degree of match is equal to or greater than a threshold value, and a comparison result between the third character string of the second document data and the document correction history meets a predetermined condition, correcting the third character string of the second document data based on the correction content indicated by the document correction history.

14. A non-transitory recording medium storing a program, which, when executed by a computer, executes a correcting method comprising:
receiving correction content indicating a change from a first character string extracted from first document data to a second character string;
storing, in a memory, a document correction history representing the correction content of the first document data, and identical document information used for determining whether an input document has an identical format with the first document data;
acquiring second document data as the input document;
extracting a third character string from the second document data;
calculating a degree of match between the second document data and the identical document information; and
when the degree of match is equal to or greater than a threshold value, and a comparison result between the third character string of the second document data and the document correction history meets a predetermined condition, correcting the third character string of the second document data based on the correction content indicated by the document correction history.
